(19) United States
(12) Patent Application Publication
(10) Pub. No.: US 2019/0327476 A1
(43) Pub. Date: Oct. 24, 2019

(54) VIDEO SIGNAL PROCESSING METHOD AND DEVICE

(71) Applicant: INDUSTRY ACADEMY COOPERATION FOUNDATION OF SEJONG UNIVERSITY, Seoul (KR)

(72) Inventors: Yung Lyul LEE, Seoul (KR); Nam Uk KIM, Seoul (KR); Kyung Hwan KO, Seoul (KR); Young Hwan YOO, Seoul (KR)

(73) Assignee: INDUSTRY ACADEMY COOPERATION FOUNDATION OF SEJONG UNIVERSITY, Seoul (KR)

(21) Appl. No.: 16/312,677

(22) PCT Filed: Jun. 23, 2017
(86) PCT No.: PCT/KR2017/006634

§ 371 Date: Dec. 21, 2018

(30) Foreign Application Priority Data
Jun. 24, 2016 (KR) 10-2016-0079137
Sep. 23, 2016 (KR) 10-2016-0121826
Sep. 23, 2016 (KR) 10-2016-0121827
Dec. 13, 2016 (KR) 10-2016-0169394

(51) Int. Cl. H04N 19/176; H04N 19/122; H04N 19/117; H04N 19/154; H04N 19/96

(52) U.S. Cl. CPC H04N 19/176; H04N 19/122; H04N 19/96; H04N 19/154; H04N 19/117

(57) ABSTRACT

According to the present invention, there is provided a video signal processing method of dividing an input image on a per-block basis for encoding, the method including: determining, at a division determination step, whether to divide a current block; dividing, at a block division step, the current block into multiple sub blocks on the basis of the determination; generating block division information on division of the current block; and encoding, at an encoding step, the block division information, the current block, or the sub blocks. Examples of division of the block according to the present invention include division using N-ary tree structures, such as the quad tree structure, the binary tree structure, and/or the triple tree structure.

### TECHNICAL FIELD

The present invention relates to a video signal processing method and device.

### BACKGROUND ART

Recently, demands for high-resolution and high-quality images such as high definition (HD) images and ultra-high definition (UHD) images have increased in various application fields. However, higher resolution and quality image data has increasing amounts of data in comparison with conventional image data. Therefore, when transmitting image data by using a medium such as conventional wired and wireless broadband networks, or when storing image data by using a conventional storage medium, costs of transmitting and storing increase. In order to solve these problems occurring with an increase in resolution and quality of image data, high-efficiency image compression techniques may be utilized.

Image compression technology includes various techniques, including: an inter-prediction technique of predicting a pixel value included in a current picture from a previous or subsequent picture of the current picture; an intra-prediction technique of predicting a pixel value included in a current picture by using pixel information in the current picture; an entropy encoding technique of assigning a short code to a value with a high appearance frequency and assigning a long code to a value with a low appearance frequency; and the like. Image data may be effectively compressed by using such image compression technology, and may be transmitted or stored.

In the meantime, in addition to demands for high-resolution images, demands for stereographic image content, which is a new image service, have also increased. A video compression technique for effectively providing stereographic image content with high resolution and ultra-high resolution is being discussed.

### DISCLOSURE

### Technical Problem

The present invention is intended to propose a method and device for encoding/decoding an image.

Also, the present invention is intended to propose a method and device for encoding/decoding an input image on the basis of adaptive division of the input image.

Also, the present invention is intended to propose a method and device for signaling adaptive division of an input image.

Also, the present invention is intended to propose a method and device for performing transforming and/or filtering on a block according to adaptive division of an input image.

Also, the present invention is intended to propose a video signal processing method and device in which noise that occurs at the corner of a block included in a video signal which is decoded on a per-block basis is effectively detected and compensation (filtering) for the detected noise is effective.

### Technical Solution

According to the present invention, there is provided a video signal processing method of dividing an input image on a per-block basis for encoding, the method including: determining, at a division determination step, whether to divide a current block; dividing, at a block division step, the current block into multiple sub blocks on the basis of the determination; generating block division information on division of the current block; and encoding, at an encoding step, the block division information, the current block, or the sub blocks.

In the video signal processing method according to the present invention, at the block division step, the current block may be divided using two or more tree structures.

In the video signal processing method according to the present invention, at the block division step, the block may be divided using at least one among the two or more tree structures as a main division structure and the others as sub division structures.

In the video signal processing method according to the present invention, the block division information includes main division information for indicating whether the block is divided using the main division structure, and when the main division information indicates that the block is divided using the main division structure and there are multiple main division structures, the block division information may further include information for specifying one among the multiple main division structures.

In the video signal processing method according to the present invention, the block division information may include main division information for indicating whether the block is divided using the main division structure, and when the main division information indicates that the block is not divided using the main division structure, the block division information may further include sub division information for indicating whether the block is divided using the sub division structure.

In the video signal processing method according to the present invention, when the sub division information indicates that the block is divided using the sub division structure and there are multiple sub division structures, the block division information may further include information for specifying one of the sub division structures.

In the video signal processing method according to the present invention, when the main division information indicates that the block is not divided using the main division structure and the sub division information indicates that the block is not divided using the sub division structure, the current block may be determined as a coding unit.

In the video signal processing method according to the present invention, the block division information may include first information for indicating whether the block is divided, and when the first information indicates that the block is divided and multiple division structures are used for dividing the block, the block division information may further include second information for specifying one among the multiple division structures.

In the video signal processing method according to the present invention, information on the main division structure or on the sub division structure may be encoded at at least one level among a sequence level, a picture level, a slice level, a tile level, and a block level.

In the video signal processing method according to the present invention, the division of the block may be not performed on a block in a predetermined size or less, and information on the predetermined size may be encoded at at least one level among a sequence level, a picture level, a slice level, a tile level, and a block level.

In the video signal processing method according to the present invention, the encoding of the current block or the sub block, at the encoding step, may include at least one among prediction, transform, and quantization, the transform may include non-square shape transform, and the transform may be performed by Y=AXB^{T} (wherein, X denotes a residual signal block in an m×n size, A denotes one-dimensional n-point transform in a horizontal direction, BT denotes one-dimensional m-point transform in a vertical direction, and Y denotes a transform block obtained by transforming X).

In the video signal processing method according to the present invention, the A and the B may be different transforms.

According to the present invention, there is provided a video signal processing method of dividing an input image on a per-block basis for decoding, the method including: decoding block division information of a current block; dividing, at a block division step, the current block into multiple sub blocks on the basis of the block division information; and decoding the current block or the sub blocks.

According to the present invention, there is provided a video signal processing device of dividing an input image on a per-block basis for encoding, the device including: a division determination module determining whether to divide a current block; a block division module dividing the current block into multiple sub blocks on the basis of the determination; a block division information generation module generating block division information on division of the current block; and an encoding module encoding the block division information, the current block, or the sub blocks.

According to the present invention, there is provided a video signal processing device of dividing an input image on a per-block basis for decoding, the device including: a block division information decoding module decoding block division information of a current block; a block division module dividing the current block into multiple sub blocks on the basis of the block division information; and a block decoding module decoding the current block or the sub blocks.

Also, according to the present invention, a video signal processing method in which an input image is divided on a per-block basis for encoding is configured to: generate a residual block for a current block; encode the residual block; decode the encoded residual block; use the decoded residual block to reconstruct the current block; and perform filtering on a reconstruction image containing the reconstructed current block, wherein the filtering is performed on the basis of shapes or sizes of two blocks adjacent to a block boundary.

In the video signal processing method according to the present invention, on the basis of the shapes or sizes of the two blocks adjacent to the block boundary, the number of pixels to be filtered or filtering strength may be determined.

In the video signal processing method according to the present invention, when at least one block among the two blocks adjacent to the block boundary is in a non-square shape, more pixels may be filtered with respect to the larger block in size among the two blocks.

In the video signal processing method according to the present invention, when at least one block among the two blocks adjacent to the block boundary is in a non-square shape, strong filtering may be applied with respect to the larger block in size among the two blocks.

In the video signal processing method according to the present invention, when the two blocks adjacent to the block boundary are different in size, more pixels may be filtered with respect to the larger block in size among the two blocks.

In the video signal processing method according to the present invention, when the two blocks adjacent to the block boundary are different in size, strong filtering may be applied with respect to the larger block in size among the two blocks.

According to the present invention, a video signal processing method in which an input image is divided on a per-block basis for decoding is configured to: decode a residual block for a current block from a bitstream; use the decoded residual block to reconstruct the current block; and perform filtering on a reconstruction image including the reconstructed current block, wherein the filtering is performed on the basis of shapes or sizes of two blocks adjacent to a block boundary.

According to the present invention, a video signal processing device in which an input image is divided on a per-block basis for encoding includes: a residual block generation module generating a residual block for a current block; a residual block encoding module encoding the residual block; a residual block decoding module decoding the encoded residual block; a current block reconstruction module using the decoded residual block to reconstruct the current block; and a filtering module performing filtering on a reconstruction image containing the reconstructed current block, wherein the filtering module performs filtering on a block boundary on the basis of shapes or sizes of two blocks adjacent to the block boundary.

According to the present invention, a video signal processing device in which an input image is divided on a per-block basis for decoding includes: a residual block decoding module decoding a residual block for a current block from a bitstream; a current block reconstruction module using the decoded residual block to reconstruct the current block; and a filtering module performing filtering on a reconstruction image containing the reconstructed current block, wherein the filtering module performs filtering on a block boundary on the basis of shapes or sizes of two blocks adjacent to the block boundary.

Also, according to the present invention, in the video signal processing method, when corners of four blocks included in a video signal decoded on a per-block basis are adjacent to each other at one intersection point, one corner pixel among four corner pixels adjacent to the intersection point may be selected as a corner outlier, and the corner outlier may be filtered, wherein the corner outlier may be selected using a difference value between pixel values of the four corner pixels adjacent to the intersection point and a first threshold value.

In the video signal processing method according to the present invention, the first threshold value may be determined on the basis of quantization parameters of the four blocks.

In the video signal processing method according to the present invention, similarity between the selected corner outlier and the pixel adjacent to the corner outlier, which is included within the same block as the corner outlier, may be determined, and the filtering may be performed on the basis of the determination of the similarity.

In the video signal processing method according to the present invention, the determination of the similarity may use a difference value between pixel values of the corner outlier and the pixel adjacent to the corner outlier, which is included within the same block as the corner outlier, and a second threshold value.

In the video signal processing method according to the present invention, the second threshold value may be determined on the basis of quantization parameters of the four blocks.

In the video signal processing method according to the present invention, whether a block boundary adjacent to the selected corner outlier is an edge of an image area may be determined, and the filtering may be performed on the basis of the determination of whether the block boundary is the edge of the image area.

In the video signal processing method according to the present invention, the determination of whether the block boundary is the edge of the image area may include first edge determination in which a variation of pixel values of pixels adjacent to the block boundary, which belong to a block adjacent to the corner outlier, and a third threshold value may be used.

In the video signal processing method according to the present invention, the third threshold value may be determined on the basis of quantization parameters of the four blocks.

In the video signal processing method according to the present invention, the determination of whether the block boundary is the edge of the image area may further include second edge determination in which a difference value between pixel values of the corner outlier and a corner pixel horizontally or vertically adjacent to the corner outlier, and a fourth threshold value may be used.

In the video signal processing method according to the present invention, the fourth threshold value may be determined on the basis of quantization parameters of the four blocks.

In the video signal processing method according to the present invention, the filtering may set a weighted average value of the four corner pixels adjacent to the intersection point as a filtered pixel value of the corner outlier.

In the video signal processing method according to the present invention, the filtering may include filtering on the pixel adjacent to the corner outlier, which is included within the same block as the corner outlier.

According to the present invention, in the video signal processing device, when corners of four blocks included in a video signal decoded on a per-block basis are adjacent to each other at one intersection point, one corner pixel among four corner pixels adjacent to the intersection point may be selected as a corner outlier, and a corner outlier filter filtering the corner outlier may be included, wherein the corner outlier may be selected using a difference value between pixel values of the four corner pixels adjacent to the intersection point and a first threshold value.

In the video signal processing device according to the present invention, the first threshold value may be determined on the basis of quantization parameters of the four blocks.

In the video signal processing device according to the present invention, the corner outlier filter may determine similarity between the selected corner outlier and the pixel adjacent to the corner outlier, which is included within the same block as the corner outlier, and the filtering may be performed on the basis of the determination of the similarity.

In the video signal processing device according to the present invention, the determination of the similarity may use a difference value between pixel values of the corner outlier and the pixel adjacent to the corner outlier, which is included within the same block as the corner outlier, and a second threshold value.

In the video signal processing device according to the present invention, the second threshold value may be determined on the basis of quantization parameters of the four blocks.

In the video signal processing device according to the present invention, the corner outlier filter may determine whether a block boundary adjacent to the selected corner outlier is an edge of an image area, and the filtering may be performed on the basis of the determination of whether the block boundary is the edge of the image area.

In the video signal processing device according to the present invention, the determination of whether the block boundary is the edge of the image area may include first edge determination in which a variation of pixel values of pixels adjacent to the block boundary, which belong to a block adjacent to the corner outlier, and a third threshold value may be used.

In the video signal processing device according to the present invention, the third threshold value may be determined on the basis of quantization parameters of the four blocks.

In the video signal processing device according to the present invention, the determination of whether the block boundary is the edge of the image area may further include second edge determination in which a difference value between pixel values of the corner outlier and the corner pixel horizontally or vertically adjacent to the corner outlier, and a fourth threshold value may be used.

In the video signal processing device according to the present invention, the fourth threshold value may be determined on the basis of quantization parameters of the four blocks.

In the video signal processing device according to the present invention, the filtering may set a weighted average value of the four corner pixels adjacent to the intersection point as a filtered pixel value of the corner outlier.

In the video signal processing device according to the present invention, the filtering may include filtering on the pixel adjacent to the corner outlier, which is included within the same block as the corner outlier.

### Advantageous Effects

The present invention may provide the method and device for encoding/decoding an image.

Also, according to the present invention, a block is adaptively divided on the basis of various types of tree structures including a quad tree structure, a binary tree structure, and/or a triple tree structure, thereby enhancing encoding efficiency.

Also, according to the present invention, division information of a block according to adaptive division of an input image is efficiently signaled, thereby enhancing encoding efficiency.

Also, according to the present invention, transforming and/or filtering is efficiently performed on a block in an arbitrary shape according to adaptive division of an input image, thereby enhancing encoding efficiency.

Also, according to the present invention, noise that occurs at the corner of a block included in a video signal which is decoded on a per-block basis is effectively detected.

Also, according to the present invention, compensation is effective for noise that occurs at the corner of a block of a video signal which is decoded on a per-block basis.

Also, according to the present invention, detection of and compensation is effective for noise that occurs at the corner of a block which is a unit of encoding/decoding processing, such that the block is used as a reference of inter prediction and/or intra prediction, whereby it is possible to prevent noise from spreading to another block or another picture.

### DESCRIPTION OF DRAWINGS

FIG. 1 is a block diagram illustrating a device for encoding an image according to an embodiment of the present invention.

FIG. 2 is a block diagram illustrating a device for decoding an image according to an embodiment of the present invention.

FIG. 3(a) is a diagram illustrating an example of a structure in which a basic block of an input image is divided using a quad tree structure.

FIG. 3(b) is a diagram illustrating an example of a structure in which a basic block of an input image is divided using a quad tree structure and/or a binary tree structure.

FIG. 4 is a diagram illustrating an example of a structure in which a block included in an input image is divided using a quad tree structure.

FIG. 5 is a diagram illustrating an example of a structure in which a block included in an input image is divided using a binary tree structure.

FIG. 6 is a diagram illustrating an example of a structure in which a block included in an input image is divided using a triple tree structure.

FIG. 7(a) is a diagram illustrating an example of a structure in which a block included in an input image is divided into multiple sub blocks using QT intersection division as a main division structure and using BT vertical 1:1 and/or BT horizontal 1:1 division as a sub division structure.

FIG. 7(b) is a diagram illustrating an example of block division information on the block division structure shown in FIG. 7(a) by using a tree structure according to an embodiment of the present invention.

FIG. 7(c) is a diagram illustrating an example of block division information on the block division structure shown in FIG. 7(a) by using a tree structure according to another embodiment of the present invention.

FIG. 8 is a diagram illustrating, when a block included in an input image is divided into multiple sub blocks using QT intersection division as a main division structure and using BT vertical 1:1 and/or BT horizontal 1:1 division as a sub division structure, examples of sizes and shapes of various blocks that the sub blocks may have.

FIG. 9(a) is a diagram illustrating an example of a structure in which a block included in an input image is divided into multiple sub blocks using QT intersection division as a main division structure and using BT vertical 1:1, BT horizontal 1:1, TT horizontal 1:2:1, and/or TT vertical 1:2:1 division as sub division structures.

FIG. 9(b) is a diagram illustrating an example of block division information on the block division structure shown in FIG. 9(a) by using a tree structure according to an embodiment of the present invention.

FIG. 10(a) is a diagram illustrating an example of a structure in which a block included in an input image is divided into multiple sub blocks using QT intersection division as a main division structure and using BT vertical 1:1, BT horizontal 1:1, BT horizontal 1:3, BT horizontal 3:1, BT vertical 1:3, and/or BT vertical 3:1 division as sub division structures.

FIG. 10(b) is a diagram illustrating an example of block division information on the block division structure shown in FIG. 10(a) by using a tree structure according to an embodiment of the present invention.

FIG. 11 is a diagram illustrating, when a block included in an input image is divided into multiple sub blocks using QT intersection division as a main division structure using BT vertical 1:1, BT horizontal 1:1, BT horizontal 1:3, BT horizontal 3:1, BT vertical 1:3, and/or BT vertical 3:1 division as sub division structures, examples of sizes and shapes of various blocks that the sub blocks may have.

FIG. 12 is a diagram illustrating examples of real number bases of DCT-II that may be used in transform and integer bases that are obtained multiplying real number bases by predetermined values.

FIG. 13 is a diagram illustrating examples of real number bases of DST-VII that may be used in transform and integer bases that are obtained multiplying real number bases by predetermined values.

FIG. 14 is a flowchart illustrating filtering according to an embodiment of the present invention.

FIG. 15 is a diagram illustrating two blocks adjacent to a block boundary and pixels therein that are used to perform filtering according to FIG. 14.

FIG. 16 is a diagram illustrating a structure of a block divided using a quad tree structure and/or a binary tree structure according to the present invention and block boundaries to which filtering is applied according thereto.

FIG. 17 is a flowchart illustrating filtering according to another embodiment of the present invention.

FIG. 18 is a diagram illustrating pixels to which strong filtering is applied according to an embodiment of the present invention.

FIG. 19 is a diagram illustrating pixels to which weak filtering is applied according to an embodiment of the present invention.

FIG. 20 is a diagram illustrating an example of a range of pixels to which filtering is applied when performing weak filtering according to the present invention.

FIG. 21(a) is a diagram illustrating a corner outlier that is a filtering target of a corner outlier filter according to an embodiment of the present invention.

FIG. 21(b) is a diagram illustrating examples of pixel values of pixels in a 2×2 area with an intersection point of FIG. 21(a) in the center.

FIG. 21(c) is a diagram illustrating indexes for indicating positions of pixels that are used to detect and filter a corner outlier.

FIG. 22 is a flowchart illustrating operation of a corner outlier filter according to an embodiment of the present invention.

### MODE FOR INVENTION

A variety of modifications may be made to the present invention and there are various embodiments of the present invention, examples of which will now be provided with reference to drawings and described in detail. However, the present invention is not limited thereto, and the exemplary embodiments can be construed as including all modifications, equivalents, or substitutes in a technical concept and a technical scope of the present invention. The similar reference numerals refer to similar elements described in the drawings.

Terms used in the specification, “first”, “second”, etc. can be used to describe various elements, but the elements are not to be construed as being limited to the terms. The terms are only used to differentiate one element from other elements. For example, the “first” element may be named the “second” element without departing from the scope of the present invention, and the “second” element may also be similarly named the “first” element. The term “and/or” includes a combination of a plurality of items or any one of a plurality of terms.

It will be understood that when an element is simply referred to as being “connected to” or “coupled to” another element without being “directly connected to” or “directly coupled to” another element in the present description, it may be “directly connected to” or “directly coupled to” another element or be connected to or coupled to another element, having the other element intervening therebetween. In contrast, it should be understood that when an element is referred to as being “directly coupled” or “directly connected” to another element, there are no intervening elements present.

The terms used in the present specification are merely used to describe particular embodiments, and are not intended to limit the present invention. An expression used in the singular encompasses the expression of the plural, unless it has a clearly different meaning in the context. In the present specification, it is to be understood that terms such as “including”, “having”, etc. are intended to indicate the existence of the features, numbers, steps, actions, elements, parts, or combinations thereof disclosed in the specification, and are not intended to preclude the possibility that one or more other features, numbers, steps, actions, elements, parts, or combinations thereof may exist or may be added.

Hereinafter, preferred embodiments of the present invention will be described in detail with reference to the accompanying drawings. Hereinafter, the same elements in the drawings are denoted by the same reference numerals, and a repeated description of the same elements will be omitted.

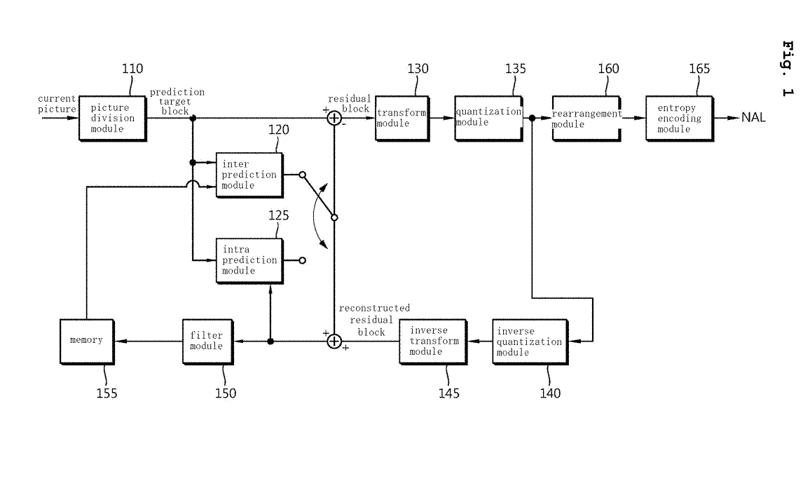

FIG. 1 is a block diagram illustrating a device for encoding an image according to an embodiment of the present invention.

Referring to FIG. 1, a device 100 for encoding an image may include a picture division module 110, prediction modules 120 and 125, a transform module 130, a quantization module 135, a rearrangement module 160, an entropy encoding module 165, an inverse quantization module 140, an inverse transform module 145, a filter module 150, and a memory 155.

The constituents shown in FIG. 1 are independently shown so as to represent characteristic functions different from each other in the device for encoding the image. Thus, it does not mean that each constituent is constituted in a constituent unit of separated hardware or software. In other words, each constituent includes each of enumerated constituents for convenience. Thus, at least two constituents of each constituent may be combined to form one constituent or one constituent may be divided into a plurality of constituents to perform each function. The embodiment where each constituent is combined and the embodiment where one constituent is divided are also included in the scope of the present invention, if not departing from the essence of the present invention.

Also, some of constituents may not be indispensable constituents performing essential functions of the present invention but be selective constituents improving only performance thereof. The present invention may be implemented by including only the indispensable constituents for implementing the essence of the present invention except the constituents used in improving performance. The structure including only the indispensable constituents except the selective constituents used in improving only performance is also included in the scope of the present invention.

The picture division module 110 may divide an input picture into one or more processing units. Here, the processing unit may be a prediction unit (PU), a transform unit (TU), or a coding unit (CU). The picture division module 110 may divide one picture into combinations of multiple coding units, prediction units, and transform units, and may encode a picture by selecting one combination of coding units, prediction units, and transform units with a predetermined criterion (for example, cost function).

For example, one picture may be divided into multiple coding units. A recursive tree structure, such as a quad tree structure, may be used to divide a picture into coding units. A coding unit which is divided into other coding units with one image or a largest coding unit as a root may be divided with child nodes corresponding to the number of divided coding units. A coding unit which is no longer divided according to a predetermined limitation serves as a leaf node. That is, when it is assumed that only square dividing is possible for one coding unit, one coding unit is divided into four other coding units at most.

In order to divide the coding unit in the picture, the tree structures may be used. The tree structures may include at least one among the quad tree structure, the binary tree structure, and/or the triple tree structure. Division is possible according to the tree structure in which one image or the largest coding unit is the root. With respect to the block resulting from the division, the tree structure may be applied again in a recursive or hierarchical manner. The tree structure applied for dividing the block that results from the division may be a tree structure different from the previously applied tree structure. A block that is no further divided is a leaf node that may be a unit of prediction, transform, and/or quantization. In the case of dividing the block using the tree structure, the leaf node may be in a square shape or non-square shape.

Hereinafter, in the embodiment of the present invention, the coding unit may mean a unit of performing encoding or a unit of performing decoding.

One or more prediction units in the same size square shape or rectangular shape may be obtained by dividing a single coding unit. Alternatively, a single coding unit may be divided into prediction units in such a manner that one prediction unit may be different from another prediction unit in shape and/or size.

When a prediction unit subjected to intra prediction based on a coding unit is generated and the coding unit is not the smallest coding unit, intra prediction is performed without division into multiple prediction units N x N.

The prediction modules 120 and 125 may include an inter prediction module 120 performing inter prediction and an intra prediction module 125 performing intra prediction. Whether to perform inter prediction or intra prediction for the prediction may be determined, and detailed information (for example, an intra prediction mode, a motion vector, a reference picture, and the like) according to each prediction method may be determined. Here, the processing unit subjected to prediction may be different from the processing unit in which the prediction method and the detailed content are determined. For example, the prediction method, the prediction mode, and the like may be determined by the prediction unit, and prediction may be performed by the transform unit. A residual value (residual block) between the generated prediction block and an original block may be input to the transform module 130. Also, prediction mode information used for prediction, motion vector information, and the like may be encoded with the residual value by the entropy encoding module 165 and may be transmitted to an device for decoding. When a particular encoding mode is used, the original block is intactly encoded and transmitted to a decoding module without generating the prediction block by the prediction modules 120 and 125.

The inter prediction module 120 may predict the prediction unit on the basis of information on at least one among a previous picture and a subsequent picture of the current picture, or in some cases may predict the prediction unit on the basis of information on some encoded regions in the current picture. The inter prediction module 120 may include a reference picture interpolation module, a motion prediction module, and a motion compensation module.

The reference picture interpolation module may receive reference picture information from the memory 155 and may generate pixel information of an integer pixel or less from the reference picture. In the case of luma pixels, an 8-tap DCT-based interpolation filter having different coefficients may be used to generate pixel information on an integer pixel or less on a per-¼ pixel basis. In the case of chroma signals, a 4-tap DCT-based interpolation filter having different filter coefficients may be used to generate pixel information on an integer pixel or less on a per-⅛ pixel basis.

The motion prediction module may perform motion prediction based on the reference picture interpolated by the reference picture interpolation module. As methods for calculating a motion vector, various methods, such as a full search-based block matching algorithm (FBMA), a three step search (TSS) algorithm, a new three-step search (NTS) algorithm, and the like may be used. The motion vector may have a motion vector value on a per-½ or -¼ pixel basis on the basis of the interpolated pixel. The motion prediction module may predict a current prediction unit by changing the motion prediction method. As motion prediction methods, various methods, such as a skip method, a merge method, an advanced motion vector prediction (AMVP) method, an intra block copy method, and the like may be used.

The intra prediction module 125 may generate a prediction unit on the basis of reference pixel information around a current block, which is pixel information in the current picture. When the nearby block of the current prediction unit is a block subjected to inter prediction and thus a reference pixel is a pixel subjected to inter prediction, reference pixel information of a nearby block subjected to intra prediction is used instead of the reference pixel included in the block subjected to inter prediction. That is, when a reference pixel is unavailable, at least one reference pixel of available reference pixels is used instead of unavailable reference pixel information.

Prediction modes in intra prediction may include a directional prediction mode using reference pixel information depending on a prediction direction and a non-directional mode not using directional information in performing prediction. A mode for predicting luma information may be different from a mode for predicting chroma information, and in order to predict the chroma information, intra prediction mode information used to predict the luma information or predicted luma signal information may be utilized.

In performing intra prediction, when the prediction unit is the same as the transform unit in size, intra prediction is performed on the prediction unit on the basis of the pixels positioned at the left, the top left, and the top of the prediction unit. However, in performing intra prediction, when the prediction unit is different from the transform unit in size, intra prediction is performed using a reference pixel based on the transform unit. Also, intra prediction using N×N division only for the smallest coding unit may be used.

In the intra prediction method, a prediction block may be generated after applying an adaptive intra smoothing (AIS) filter to a reference pixel depending on the prediction modes. The type of AIS filter applied to the reference pixel may vary. In order to perform the intra prediction method, an intra prediction mode of the current prediction unit may be predicted from the intra prediction mode of the prediction unit around the current prediction unit. In predicting the prediction mode of the current prediction unit by using mode information predicted from the nearby prediction unit, when the intra prediction mode of the current prediction unit is the same as the intra prediction mode of the nearby prediction unit, information indicating that the current prediction unit and the nearby prediction unit have the same prediction mode is transmitted using predetermined flag information. When the prediction mode of the current prediction unit is different from the prediction mode of the nearby prediction unit, entropy encoding is performed to encode prediction mode information of the current block.

Also, a residual block may be generated on the basis of prediction units generated by the prediction modules 120 and 125, wherein the residual block includes information on a residual value which is a difference value between the prediction unit subjected to prediction and the original block of the prediction unit. The generated residual block may be input to the transform module 130.

The transform module 130 may transform the residual block, which includes the information on the residual value between the original block and the prediction units generated by the prediction modules 120 and 125, by using a transform method, such as discrete cosine transform (DCT), discrete sine transform (DST), and KLT. Whether to apply DCT, DST, or KLT in order to transform the residual block may be determined on the basis of intra prediction mode information of the prediction unit which is used to generate the residual block.

The quantization module 135 may quantize values transformed into a frequency domain by the transform module 130. Quantization coefficients may vary according to a block or importance of an image. The values calculated by the quantization module 135 may be provided to the inverse quantization module 140 and the rearrangement module 160.

The rearrangement module 160 may perform rearrangement of coefficient values with respect to quantized residual values.

The rearrangement module 160 may change a coefficient in the form of a two-dimensional block into a coefficient in the form of a one-dimensional vector through a coefficient scanning method. For example, the rearrangement module 160 may scan from a DC coefficient to a coefficient in a high frequency domain using a zigzag scanning method so as to change the coefficients to be in the form of a one-dimensional vector. Depending on the size of the transform unit and the intra prediction mode, vertical direction scanning where coefficients in the form of two-dimensional block are scanned in the column direction or horizontal direction scanning where coefficients in the form of two-dimensional block are scanned in the row direction may be used instead of zigzag scanning. That is, which scanning method among zigzag scanning, vertical direction scanning, and horizontal direction scanning is used may be determined depending on the size of the transform unit and the intra prediction mode.

The entropy encoding module 165 may perform entropy encoding based on the values calculated by the rearrangement module 160. Entropy encoding may use various encoding methods, for example, exponential Golomb coding, context-adaptive variable length coding (CAVLC), and context-adaptive binary arithmetic coding (CABAC).

The entropy encoding module 165 may encode a variety of information, such as residual value coefficient information and block type information of the coding unit, prediction mode information, division unit information, prediction unit information, transmission unit information, motion vector information, reference frame information, block interpolation information, filtering information, and the like from the rearrangement module 160 and the prediction modules 120 and 125.

The entropy encoding module 165 may entropy encode the coefficient values of the coding unit input from the rearrangement module 160.

The inverse quantization module 140 may inversely quantize the values quantized by the quantization module 135 and the inverse transform module 145 may inversely transform the values transformed by the transform module 130. The residual value generated by the inverse quantization module 140 and the inverse transform module 145 may be combined with the prediction unit predicted by a motion estimation module, a motion compensation unit, and the intra prediction module of the prediction modules 120 and 125 such that a reconstructed block can be generated.

The filter module 150 may include at least one of a deblocking filter, an offset correction module, and an adaptive loop filter (ALF).

The deblocking filter may remove block distortion that occurs due to boundaries between the blocks in the reconstructed picture. In order to determine whether to perform deblocking, whether to apply the deblocking filter to the current block may be determined on the basis of the pixels included in several rows and columns in the block. When the deblocking filter is applied to the block, a strong filter or a weak filter is applied depending on required deblocking filtering intensity. Also, in applying the deblocking filter, when performing horizontal direction filtering and vertical direction filtering, horizontal direction filtering and vertical direction filtering are configured to be processed in parallel.

In performing deblocking filtering, adaptive filtering may be performed according to the shapes, sizes, and/or characteristics of two blocks P and Q adjacent to the block boundary. For example, when the two blocks P and Q are different in size, more pixels are filtered with respect to the large size block than the small size block. Also, on the basis of whether at least one among the two blocks P and Q is a non-square block or not, adaptive filtering may be performed. For example, when the block P is an 8×8 block and the block Q is an 8×16 block, in filtering of the block boundary where the blocks P and Q are adjacent to each other, more pixels are filtered with respect to the block Q than the block P.

When the two blocks P and Q adjacent to the block boundary are different in size or at least one thereof is the non-square block, the two blocks P and Q have the same number of pixels to be filtered, but filtering with different strengths is performed on the blocks P and Q, respectively. Alternatively, different numbers of pixels to be filtered and different filtering strengths may be applied with respect to the two blocks P and Q.

The offset correction module may correct an offset from the original image on a per-pixel basis with respect to the image subjected to deblocking. In order to perform offset correction on a particular picture, used is a method of separating pixels of the image into the predetermined number of regions, determining a region to be subjected to offset, and applying the offset to the determined region or a method of applying an offset in consideration of edge information of each pixel.

Adaptive loop filtering (ALF) may be performed on the basis of the value obtained by comparing the filtered reconstruction image and the original image. The pixels included in the image may be divided into predetermined groups, a filter to be applied to each of the groups may be determined, and filtering may be individually performed on each group. Information on whether to apply ALF and a luma signal may be transmitted for each coding unit (CU). The form and filter coefficient of a filter for ALF to be applied may vary according to each block. Also, the filter for ALF in the same form (fixed form) may be applied regardless of the characteristic of the application target block.

The memory 155 may store the reconstruction block of the picture calculated through the filter module 150. The stored reconstruction block or picture may be provided to the prediction modules 120 and 125 in performing inter prediction.

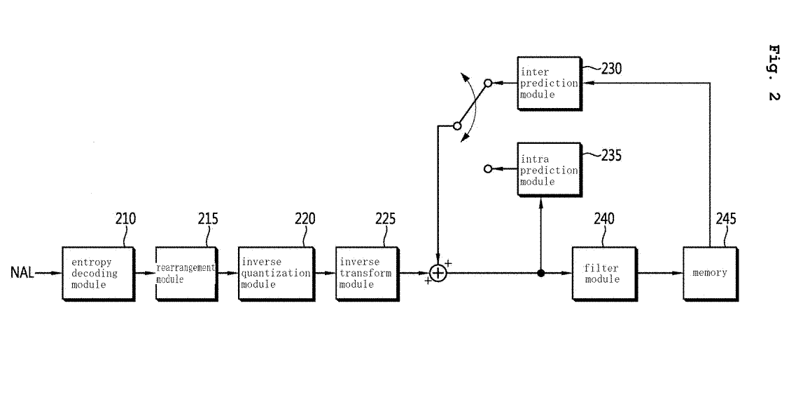

FIG. 2 is a block diagram illustrating a device for decoding an image according to an embodiment of the present invention.

Referring to FIG. 2, a device 200 for decoding an image may include an entropy decoding module 210, a rearrangement module 215, an inverse quantization module 220, an inverse transform module 225, prediction modules 230 and 235, a filter module 240, and a memory 245.

When an image bitstream is input from the device for encoding the image, the input bitstream is decoded according to an inverse process of the device for encoding the image.

The entropy decoding module 210 may perform entropy decoding according to the inverse process of the entropy encoding by the entropy encoding module of the device for encoding the image. For example, corresponding to the methods performed by the device for encoding the image, various methods, such as exponential Golomb coding, context-adaptive variable length coding (CAVLC), and context-adaptive binary arithmetic coding (CABAC) may be applied.

The entropy decoding module 210 may decode information on intra prediction and inter prediction performed by the device for encoding.

The rearrangement module 215 may perform rearrangement on the bitstream entropy decoded by the entropy decoding module 210 on the basis of the rearrangement method used in the device for encoding. The coefficients expressed in the form of the one-dimensional vector may be reconstructed and rearranged into the coefficients in the form of the two-dimensional block. The rearrangement module 215 may perform rearrangement through a method of receiving information related to coefficient scanning performed in the device for encoding and of inversely scanning on the basis of the scanning order performed in the device for encoding.

The inverse quantization module 220 may perform inverse quantization on the basis of a quantization parameter received from the device for encoding and the rearranged coefficient values of the block.

The inverse transform module 225 may perform, on the quantization result obtained by the device for encoding the image, inverse transform, namely, inverse DCT, inverse DST, and inverse KLT that are the inverse of transform, which is DCT, DST, and KLT, performed by the transform module.

Inverse transform may be performed on the basis of a transmission unit determined by the device for encoding the image. The inverse transform module 225 of the device for decoding the image may selectively perform transform techniques (for example, DCT, DST, and KLT) depending on multiple pieces of information, such as the prediction method, the size of the current block, the prediction direction, and the like.

The prediction modules 230 and 235 may generate a prediction block on the basis of information on prediction block generation received from the entropy decoding module 210 and information on a previously decoded block or picture received from the memory 245.

As described above, like operation of the device for encoding the image, in performing intra prediction, when the prediction unit is the same as the transform unit in size, intra prediction is performed on the prediction unit on the basis of the pixels positioned at the left, the top left, and the top of the prediction unit. However, in performing intra prediction, when the prediction unit is different from the transform unit in size, intra prediction is performed using a reference pixel based on the transform unit. Also, intra prediction using N×N division only for the smallest coding unit may be used.

The prediction modules 230 and 235 may include a prediction unit determination module, an inter prediction module, and an intra prediction module. The prediction unit determination module may receive a variety of information, such as prediction unit information, prediction mode information of an intra prediction method, information on motion prediction of an inter prediction method, and the like from the entropy decoding module 210, may separate a prediction unit in a current coding unit, and may determine whether inter prediction or intra prediction is performed on the prediction unit. By using information required in inter prediction of the current prediction unit received from the device for encoding the image, the inter prediction module 230 may perform inter prediction on the current prediction unit on the basis of information on at least one among a previous picture and a subsequent picture of the current picture including the current prediction unit. Alternatively, inter prediction may be performed on the basis of information on some pre-reconstructed regions in the current picture including the current prediction unit.

In order to perform inter prediction, it may be determined which of a skip mode, a merge mode, and an AMVP mode is used as the motion prediction method of the prediction unit included in the coding unit, on the basis of the coding unit.

The intra prediction module 235 may generate a prediction block on the basis of pixel information in the current picture. When the prediction unit is a prediction unit subjected to intra prediction, intra prediction is performed on the basis of intra prediction mode information of the prediction unit received from the device for encoding the image. The intra prediction module 235 may include an adaptive intra smoothing (AIS) filter, a reference pixel interpolation module, and a DC filter. The AIS filter performs filtering on the reference pixel of the current block, and whether to apply the filter may be determined depending on the prediction mode of the current prediction unit. The prediction mode of the prediction unit received from the device for encoding the image and AIS filter information are used for performing AIS filtering on the reference pixel of the current block. When the prediction mode of the current block is a mode in which AIS filtering is not performed, the AIS filter is not applied.

When the prediction mode of the prediction unit is a prediction mode in which intra prediction is performed on the basis of the pixel value obtained by interpolating the reference pixel, the reference pixel interpolation module may interpolate the reference pixel to generate the reference pixel in units of a pixel of an integer value or less. When the prediction mode of the current prediction unit is a prediction mode in which a prediction block is generated without interpolating the reference pixel, the reference pixel is not interpolated. The DC filter may generate a prediction block through filtering when the prediction mode of the current block is a DC mode.

The reconstructed block or picture may be provided to the filter module 240. The filter module 240 may include the deblocking filter, the offset correction module, and the ALF.

From the device for encoding the image, received is information on whether the deblocking filter is applied to the relevant block or picture and information on whether the strong filter or the weak filter is applied when the deblocking filter is applied. The deblocking filter of the device for decoding the image may receive information on the deblocking filter from the device for encoding the image, and the device for decoding the image may perform deblocking filtering on the relevant block.

The offset correction module may perform offset correction on the reconstructed image on the basis of the type of offset correction, offset value information, and the like applied to the image in performing encoding.

The ALF may be applied to the coding unit on the basis of information on whether to apply the ALF, ALF coefficient information, and the like received from the device for encoding. The ALF information may be provided as being included in a particular parameter set.

The memory 245 may store the reconstructed picture or block for use as a reference picture or a reference block, and may provide the reconstructed picture to an output module.

As described above, hereinafter, in the embodiment of the present invention, for convenience of description, the coding unit is used as a term representing encoding unit, but the coding unit may serve as a unit performing decoding as well as encoding.

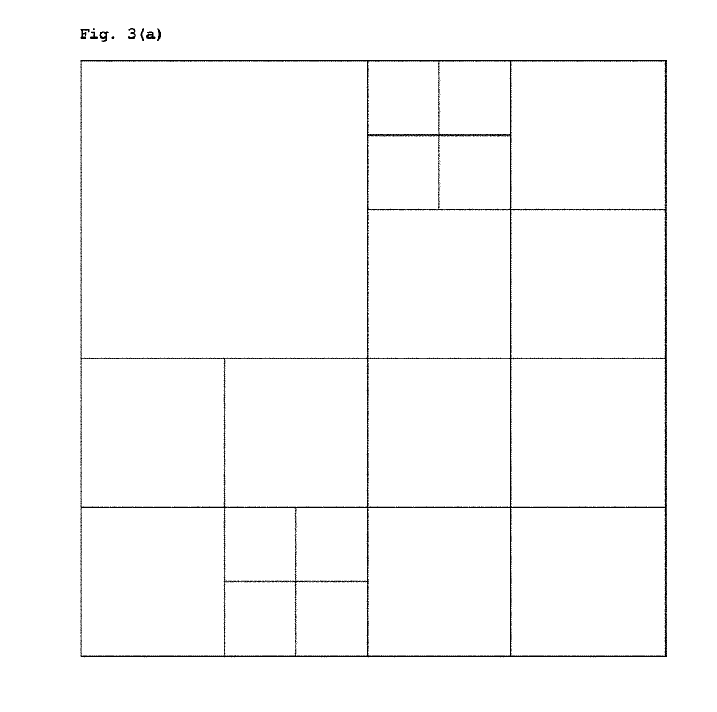

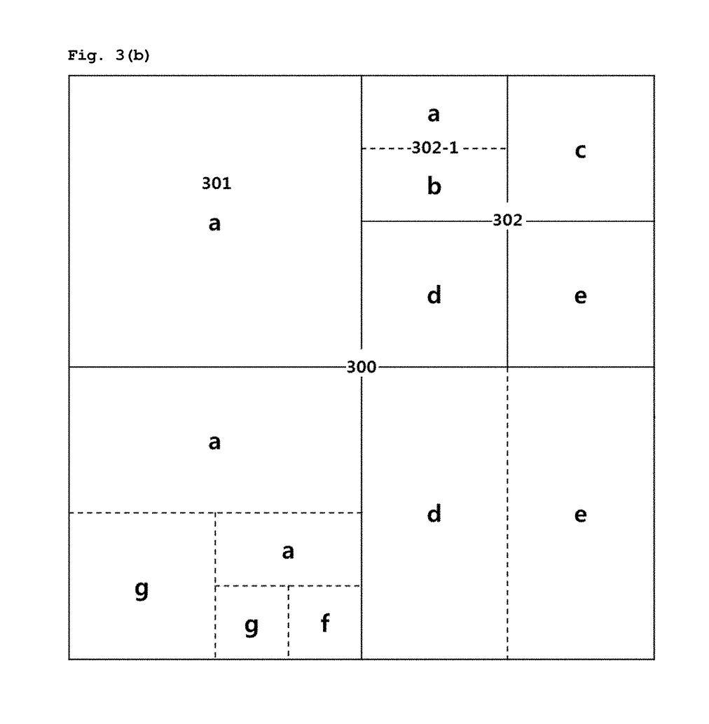

FIG. 3(a) is a diagram illustrating an example of a structure in which a basic block of an input image is divided into multiple sub blocks using the quad tree structure according to an embodiment of the present invention.

FIG. 3(b) is a diagram illustrating an example of a structure in which the basic block of the input image is divided into multiple sub blocks using the quad tree structure and/or the binary tree structure.

The input image to be encoded, for efficient encoding, may be divided into units of basic block and encoded. The basic block in the present invention may be defined as the largest coding unit (LCU) or as a coding tree unit (CTU). The basic blocks may be in the shape of a predetermined rectangle in a M×N size or of a predetermined square. M and N may be integers having values of 2ⁿ (n is an integer larger than one), M denotes the horizontal length of the block, and N denotes the vertical length of the block. The LCU or CTU may be in the size of a square, such as 64×64, and 128×128. These basic blocks may be further divided to efficiently perform image compression.

In order to efficiently perform image compression, it is desired that the image is divided into homogeneous areas according to homogeneity. The homogeneous area means that there is no change between values of luma and/or chroma of the sample included in the area or that the change is equal to or less than a predetermined threshold value. That is, the homogeneous area may consist of samples having homogeneous sample values, and homogeneity may be determined according to a predetermined determination criterion. Considering homogeneity of the image, when dividing the basic block into multiple sub blocks that are homogeneous areas, energy of a prediction residual signal of the sub block is efficiently concentrated, thereby enhancing compression efficiency in transform and quantization.

In order to divide the basic block within the input image into multiple sub blocks according to homogeneity, the binary tree structure, the quad tree structure, the triple tree structure, an octree Structure, and/or a general N-ary tree structure may be used. It is possible that the basic block is divided into multiple sub blocks using at least one among the multiple tree structures.

FIG. 3(a) illustrates an example in which the basic block is divided into multiple sub blocks only using the quad tree structure. In the quad tree structure, a block that is a target of division is divided into four blocks in the same block size. The four blocks resulting from the division may be further divided according to the quad tree structure.

FIG. 3(b) illustrates an example in which the basic block is divided into multiple sub blocks using the quad tree structure and/or the binary tree structure. The letter shown in each sub block resulting from the division is an index that indicates homogeneity. For example, the sub blocks designated by the letter a indicate areas all having the same homogeneity. Further, in FIG. 3(b), the reference numeral shown inside the block indicates the relevant block, and the reference numerals shown at the boundaries of the blocks indicate blocks divided by the relevant boundaries.

As shown in FIGS. 3(a) and 3(b), the basic block may be divided into multiple sub blocks. The sub block that is no further divided may be determined as the coding unit. In FIGS. 3(a) and 3(b), the coding unit may be a unit of coding, such as prediction, transform, and/or quantization. Alternatively, to perform prediction, transform, and/or quantization, the coding unit may be further divided. For example, for prediction of the coding unit, division according to the quad tree structure, division according to the binary tree structure, or asymmetric division may be performed. Alternatively, division in various shapes rather than the shape of a square or rectangle may be considered. Also, for transform and/or quantization of the coding unit, the division method that may be used for the prediction may be also applied.

When dividing the basic block of the input image, information indicating whether to use the quad tree structure and/or binary tree structure may be signaled in a bitstream. Information on the division structure of the basic block of the input image may be signaled, for example, on a per-sequence basis, a per-picture basis, a per-slice basis, a per-tile basis, and/or a per-basic block basis. For example, when the information is signaled on a per-picture basis, indicated is whether to use both the quad tree structure and the binary tree structure or only the quad tree structure with respect to all basic blocks or some basic blocks included in the relevant picture. When determining that only the quad tree structure is used, block division information of the basic block includes division information according to the quad tree structure and does not include division information according to the binary tree structure.

As described above, in the quad tree structure, a block that is a target of division is divided into four blocks in the same block size. Further, in the binary tree structure, a block that is a target of division is divided into two blocks in the same block size. When the block is divided using the binary tree structure, it is necessary to encode/decode information, together, on division direction indicating whether division is in a horizontal direction or a vertical direction. A method of encoding/decoding the division information of the block will be described later.

As described in FIG. 3(b), for example, a basic block 300 may be divided into four sub blocks using the quad tree structure. When the block is divided using the tree structure, the depth of each block is determined on the basis of the depth in the tree structure. The basic block 300 corresponds to a block with the depth of zero in the tree structure. The sub block obtained by dividing the basic block 300 corresponds to a block with the depth of one. The four sub blocks (depth=1) obtained by the division may be the same in size. Among the four sub blocks, the sub block (depth=1) 301 that is positioned on the upper left side may not be further divided. For example, when the sub block (depth=1) 301 that is positioned on the upper left side is determined as the homogeneous area, the sub block 301 is not further divided. The sub block (depth=1) 301 that is not further divided may be determined as the coding unit.

For example, among the four sub blocks that results from the division of the basic block (depth=0) 300 using the quad tree structure, a sub block (depth=1) 302 that is positioned on the upper right side may be further divided into four sub blocks (depth=2) using the quad tree structure in a recursive or hierarchical manner. Each of the sub blocks (depth=2) resulting from the further division may be determined as the coding unit. Alternatively, like a sub block (depth=2) 302-1 on the upper left side of the sub block (depth=1) 302 which is positioned on the upper right side of the basic block (depth=0) 300, the further division may be performed using the binary tree structure. When it is determined that the block resulting from the division is no further divided or is the homogeneous area which does not need to be divided, the block is determined as the coding unit.

As described in FIG. 3(b), when the basic block is divided using the quad tree structure and/or the binary tree structure, the block is divided into homogeneous areas in various sizes more adaptively, compared with the case in FIG. 3(a) of using only the quad tree structure in division.

As described above, the coding unit may be further divided for prediction, transform, and/or quantization. However, when division takes place by the method shown in FIG. 3(b), the homogeneous area with extremely high accuracy is determined as the coding unit. Therefore, for prediction, transform, and/or quantization, the coding unit may not be further divided. That is, the coding unit itself may be a prediction unit, which is a unit of prediction, and/or a transform unit, which is a unit of transform. Since the coding unit is intactly used as the prediction unit and/or the transform unit, the cost of dividing the coding unit into prediction units and/or transform units is saved.

Particularly, it is not necessary to encode the division information on the type in which the coding unit is divided into prediction units and/or transform units, as a syntax element, such that compression efficiency may be enhanced. Also, as described above, according to the block division method described with reference to FIG. 3(b), each sub block that is determined as the coding unit is the homogeneous area with extremely high accuracy, such that concentration of the energy of the residual signal is highly efficient, whereby compression efficiency in transform and/or quantization may be enhanced.

According to the present invention, the basic block may be divided into multiple coding units using the quad tree structure and/or the binary tree structure. The quad tree structure and the binary tree structure may be appropriately selected for use as needed regardless of order. Alternatively, the quad tree structure may be used as the main division structure, and the binary tree structure may be used as the sub division structure. Alternatively, the binary tree structure may be used as the main division structure, and the quad tree structure may be used as the sub division structure. When one is the main division structure and the other one is the sub division structure, division according to the main division structure is performed first. When reaching the leaf node in the main division structure, the leaf node is the root node in the sub division structure and is divided according to the sub division structure.

In encoding, when the basic block is divided by a predetermined combination of tree structures for encoding, it is necessary to signal information (hereinafter, referred to as “block division information”) on tree structures used for dividing the basic block, type, direction, and/or ratio of division. The device for decoding may decode the block division information of the basic block on the basis of information transmitted as being included in the bitstream or of information derived by decoding the bitstream, and then may decode the basic block on the basis of the block division information.

When the basic block is divided on the basis of the tree structure and a node that is no further divided is reached, the node that is no further divided corresponds to the leaf node. The leaf node may be a unit of performing prediction, transform, and/or quantization, and, for example, may correspond to the coding unit (CU) defined in the specification. The coding unit corresponding to the leaf node may be 2ⁿ×2ⁿ, 2ⁿ×2^{m}, or 2n×2m (n and m are integers larger than one) in size.

Hereinafter, a method of dividing the basic block with at least one combination of the quad tree, the binary tree, and/or the triple tree and of constructing the block division information corresponding thereto for encoding/decoding will be described. However, the tree structures used for dividing the block according to the present invention are not limited to the quad tree, the binary tree, and/or the triple tree, and may be widely applied to division of the block using the N-ary tree structure as described above.

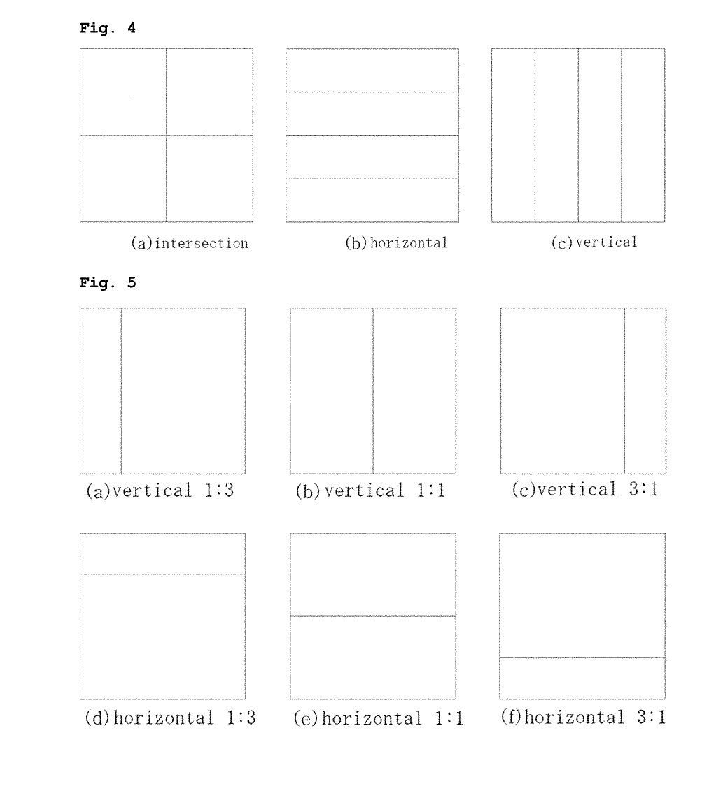

FIG. 4 is a diagram illustrating examples of structures in which the block included in the input image is divided into multiples sub blocks using the quad tree structure according to an embodiment of the present invention.

When the current block is divided using the quad tree structure, the current block is divided into four sub blocks.

For example, as described in FIG. 4(a), the current block may be divided to generate four sub blocks using two intersecting lines. This division type may be defined as “QT intersection” in the specification. Here, “QT” means the quad tree. In this case, the horizontal and vertical lengths of the sub block that results from the division correspond to halves of those of the block not subjected to division yet.

Alternatively, as described in FIG. 4(b), the current block may be divided to generate four sub blocks using three horizontal lines. This division type may be defined as “QT horizontal” in the specification. In this case, the horizontal length of the sub block resulting from the division is the same as that of the block not subjected to division yet, and the vertical length corresponds to ¼ of the block not subjected to division yet.

Alternatively, as described in FIG. 4(c), the current block may be divided to generate four sub blocks using three vertical lines. This division type may be defined as “QT vertical” in the specification. In this case, the vertical length of the sub block resulting from the division is the same as that of the block not subjected to division yet, and the horizontal length corresponds to ¼ of the block not subjected to division yet.

The division of the block using the quad tree structures are not limited to examples in FIGS. 4(a) to 4(c), and various ratios may be defined for use. For example, the block may be divided in a ratio of 1:1:1:2, 1:2:2:4, and the like. That is, the division of the block using the quad tree structure may include all division types in which the target block is divided into four sub blocks in an arbitrary ratio.

FIG. 5 is a diagram illustrating examples of structures in which the block included in the input image is divided into multiples sub blocks using the binary tree structure according to an embodiment of the present invention.

When the current block is divided using the binary tree structure, the current block is divided into two sub blocks.

For example, as described in FIG. 5(a), the current block may be divided to generate two sub blocks using the vertical line in a ratio of 1:3. This division type may be defined as “BT vertical 1:3” in the specification. Here, “the BT” means the binary tree. The vertical length of each of the two sub blocks resulting from the division is the same as that of the block not subjected to division yet, and the ratio between the horizontal lengths of the two sub blocks resulting from the division is 1:3.

Alternatively, as described in FIG. 5(b), the current block may be divided to generate two sub blocks using the vertical line in a ratio of 1:1. This division type may be defined as “BT vertical 1:1” in the specification. The vertical length of each of the two sub blocks resulting from the division is the same as that of the block not subjected to division yet, and the ratio between the horizontal lengths of the two sub blocks resulting from the division is 1:1.

Alternatively, as described in FIG. 5(c), the current block may be divided to generate two sub blocks using the vertical line with a ratio of 3:1. This division type may be defined as “BT vertical 3:1” in the specification. The vertical length of each of the two sub blocks resulting from the division is the same as that of the block not subjected to division yet, and the ratio between the horizontal lengths of the two sub blocks resulting from the division is 3:1.

Alternatively, as described in FIG. 5(d), the current block may be divided to generate two sub blocks using the horizontal line in a ratio of 1:3. This division type may be defined as “BT horizontal 1:3” in the specification. The horizontal length of each of the two sub blocks resulting from the division is the same as that of the block not subjected to division yet, and the ratio between the vertical lengths of the two sub blocks resulting from the division is 1:3.

Alternatively, as described in FIG. 5(e), the current block may be divided to generate two sub blocks using the horizontal line in a ratio of 1:1. This division type may be defined as “BT horizontal 1:1” in the specification. The horizontal length of each of the two sub blocks resulting from the division is the same as that of the block not subjected to division yet, and the ratio between the vertical lengths of the two sub blocks resulting from the division is 1:1.

Alternatively, as described in FIG. 5(f), the current block may be divided to generate two sub blocks using the horizontal line in a ratio of 3:1. This division type may be defined as “BT horizontal 3:1” in the specification. The horizontal length of each of the two sub blocks resulting from the division is the same as that of the block not subjected to division yet, and the ratio between the vertical lengths of the two sub blocks resulting from the division is 3:1.

The division of the block using the binary tree structures are not limited to examples in FIGS. 5(a) to 5(f), and various ratios may be defined for use. For example, the block may be divided in a ratio of 1:2, 1:4, 1:5, and the like. That is, the division of the block using the binary tree structure may include all division types in which the target block is divided into two sub blocks in an arbitrary ratio.

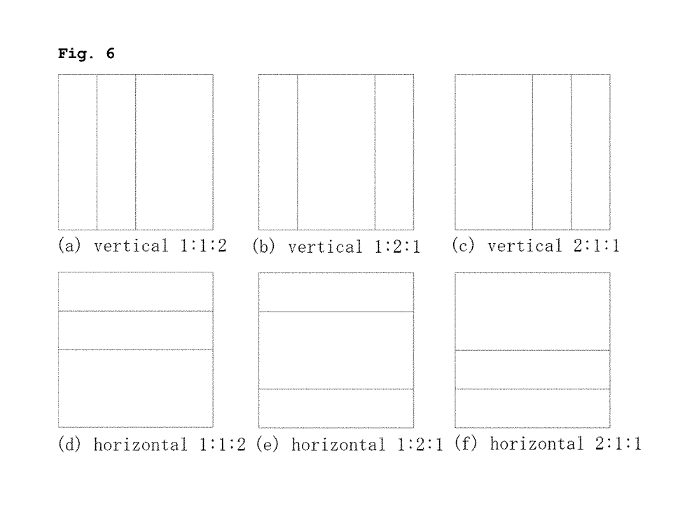

FIG. 6 is a diagram illustrating examples of structures in which the block included in the input image is divided into multiples sub blocks using the triple tree structure according to an embodiment of the present invention.

When the current block is divided using the triple tree structure, the current block is divided into three sub blocks.

For example, as described in FIG. 6(a), the current block may be divided to generate three sub blocks using two vertical lines in a ratio of 1:1:2. This division type may be defined as “TT vertical 1:1:2” in the specification. Here, “the TT” means the triple tree. The vertical length of each of the three sub blocks resulting from the division is the same as that of the block not subjected to division yet, and the ratio between the horizontal lengths of the three sub blocks resulting from the division is 1:1:2.

Alternatively, as described in FIG. 6(b), the current block may be divided to generate three sub blocks using two vertical lines in a ratio of 1:2:1. This division type may be defined as “TT vertical 1:2:1” in the specification. The vertical length of each of the three sub blocks resulting from the division is the same as that of the block not subjected to division yet, and the ratio between the horizontal lengths of the three sub blocks resulting from the division is 1:2:1.

Alternatively, as described in FIG. 6(c), the current block may be divided to generate three sub blocks using two vertical lines in a ratio of 2:1:1. This division type may be defined as “TT vertical 2:1:1” in the specification. The vertical length of each of the three sub blocks resulting from the division is the same as that of the block not subjected to division yet, and the ratio between the horizontal lengths of the three sub blocks resulting from the division is 2:1:1.

Alternatively, as described in FIG. 6(d), the current block may be divided to generate three sub blocks using two horizontal lines in a ratio of 1:1:2. This division type may be defined as “TT horizontal 1:1:2” in the specification. The horizontal length of each of the three sub blocks resulting from the division is the same as that of the block not subjected to division yet, and the ratio between the vertical lengths of the three sub blocks resulting from the division is 1:1:2.

Alternatively, as described in FIG. 6(e), the current block may be divided to generate three sub blocks using two horizontal lines in a ratio of 1:2:1. This division type may be defined as “TT horizontal 1:2:1” in the specification. The horizontal length of each of the three sub blocks resulting from the division is the same as that of the block not subjected to division yet, and the ratio between the vertical lengths of the three sub blocks resulting from the division is 1:2:1.

Alternatively, as described in FIG. 6(f), the current block may be divided to generate three sub blocks using two horizontal lines in a ratio of 2:1:1. This division type may be defined as “TT horizontal 2:1:1” in the specification. The horizontal length of each of the three sub blocks resulting from the division is the same as that of the block not subjected to division yet, and the ratio between the vertical lengths of the three sub blocks resulting from the division is 2:1:1.

The division of the block using the triple tree structures are not limited to examples in FIGS. 6(a) to 6(f), and various ratios may be defined for use. For example, the block may be divided in a ratio of 1:2:2, 1:2:4, 1:2:5, and the like. That is, the division of the block using the triple tree structure may include all division types in which the target block is divided into three sub blocks in an arbitrary ratio.

As described above with reference to FIGS. 4 to 6, one block may be divided into multiple sub blocks according to the quad tree structure, the binary tree structure, and/or the triple tree structure. Further, with respect to each of the multiple sub blocks obtained by the division, division according to the quad tree structure, the binary tree structure, and/or the triple tree structure may be performed again in a recursive or hierarchical manner.

According to the embodiment shown in FIG. 4, examples of division of the block using QT may include three division types. Also, according to the embodiments shown in FIGS. 5 and 6, examples of division of the block using the BT or TT may include six division types, respectively. Accordingly, the block division information is required to include information (tree structure information) that indicates the tree structure used for dividing the current block. Also, the block division information is required to include information (division type information) that indicates one division type of multiple division types according to the selected tree structure.

On the basis of the number of tree structures that may be used for dividing the block, the number of bits required to encode the tree structure information may be determined. Also, on the basis of the number of division types included one tree structure, the number of bits required to encode the division type information may be determined.

The type of tree structure that may be used for dividing the block may be predetermined in the device for encoding and in the device for decoding. Alternatively, the type of tree structure that may be used for dividing the block may be encoded by the device for encoding and transmitted in a bitstream to the device for decoding. Information on the type of tree structure may be encoded into at least one level among a sequence level, a picture level, a slice level, a tile level, and a basic block level, for transmission. For example, with respect to a particular slice, when the block is divided using only QT, information indicating that QT is used for dividing the block may be signaled via the slice header, and the like. For example, with respect to a particular slice, when the block is divided using the QT, BT, and TT, information indicating that the QT, BT, and TT are used for dividing the block may be signaled via the slice header, and the like. In the case where the device for encoding and the device for decoding have determined the division structure used as default already, even though the relevant information is not transmitted, which tree structure is used at the relevant level is signaled. Alternatively, the type of tree structure that may be used at a lower level may be limited to a part or all of the types of tree structures that may be used at a higher level. For example, when signaling that the QT and BT are used via the sequence header, it is determined that only a combination of the QT and BT or of the QT and BT is used and the TT is unavailable in the picture included in the relevant sequence. For example, when the information on the tree structure that may be used for dividing the block is not transmitted, information signaled at the higher level is intactly inherited.

In the specification, examples of the information being signaled include information that is explicitly signaled in a bitstream as well as information that is implicitly signaled.

As described above, when the tree structure or a combination of multiple tree structures that may be used with respect to the current level is selected, information corresponding thereto is signaled. The block included in the current level may be divided using one of the available tree structures. When three tree structures are available for the current level, at least two bits are required to encode the tree structure information. For example, the tree structure information indicating division by the QT may be expressed as one bit. For example, the tree structure information indicating division by one of the BT and the TT may be expressed as two bits.

When the tree structure used for dividing the block is specified, it is necessary to specify one of division types according to the tree structure. For example, as described in FIG. 6, since there are six division types according to TT, when the current block is divided using TT, the division type information for specifying one of the six division types is necessary. Here, the number of bits required to encode the division type information may be determined considering the six available division types. For example, through calculation of ceil(log₂(6)), the number of required bits is determined to be three. Here, ceil( ) means a raising function.

Even though the tree structure used in division of the block is determined, it is not necessary to use all division types included in division by the relevant tree structure. For example, only some of the six division types in FIG. 6 may be used. In this case, the number of bits required to encode the division type information may be reduced. Information indicating which division type of division types included in division by the relevant tree structure may be encoded into at least one level among a sequence level, a picture level, a slice level, a tile level, and a basic block level, for transmission.

As shown in FIGS. 4 to 6, some division types may be derived from other division types. For example, the division type in FIG. 5(d) may be obtained by merging the three lower blocks in the division type in FIG. 4(b). Therefore, not all division types shown in FIGS. 4 to 6 may be used. For example, via the tree structure information and the division type information, encoded or decoded is which tree structure is used with respect to at least one among the relevant sequence, picture, slice, tile, and basic block and/or which division type among multiple division types is used.

When the block is divided using two or more tree structures, an application order of tree structures is predetermined. The order of tree structures may be predetermined in the device for encoding/the device for decoding or may be encoded into at least one level among a sequence level, a picture level, a slice level, a tile level, and a basic block level, for transmission.

For example, division according to the QT may be the main division, and division according to the BT/TT may be the sub division. In this case, division according to the QT may be performed first, and division according to the BT/TT may be performed on the leaf node of the QT, on which division according to the QT is no further performed. When the block is divided using the main division and sub division structures, the number of bits required to encode the tree structure information and/or the division type information is more reduced. Here, when there are two or more tree structures that may be used as sub division structures, division takes place using one sub division structure without determining a particular order. Alternatively, the order of the multiple sub division structures is determined again, and then the block is divided. For example, a hierarchical structure may be used that the QT is used as the main division structure, the leaf node of the QT is divided using the BT, and the leaf node of the BT is divided using the TT.

In each case, the number of bits required to express the tree structure information and/or the division type information may vary.

Information on which tree structure among the multiple tree structures is used as the main division structure and on whether a predetermined use order of the multiple sub division structures is present or not may be predetermined in the device for encoding/the device for decoding or may be encoded into at least one level among a sequence level, picture level, slice level, tile level, and a basic block level for transmission.

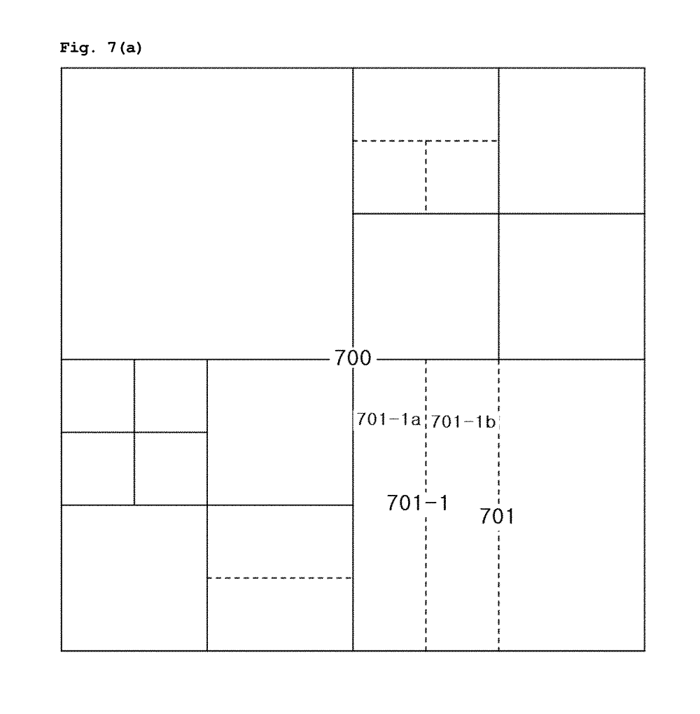

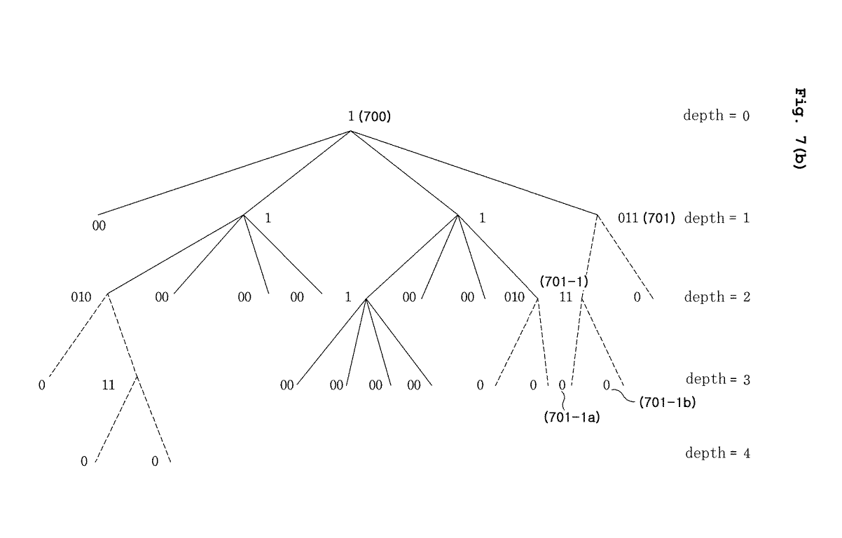

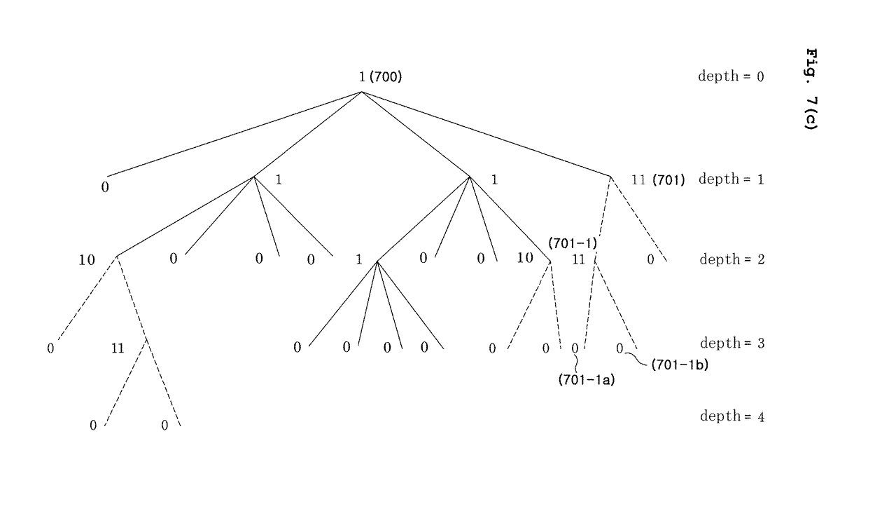

FIG. 7(a) is a diagram illustrating an example of a structure in which a block included in an input image is divided into multiple sub blocks using QT intersection division as a main division structure and using BT vertical 1:1 and/or BT horizontal 1:1 division as a sub division structure. In FIG. 7(a), the reference numeral shown inside the block indicates the relevant block, and the reference numerals shown at the boundaries of the blocks indicate blocks divided by the relevant boundaries.

FIG. 7(b) is a diagram illustrating an example of block division information on the block division structure shown in FIG. 7(a) by using a tree structure according to an embodiment of the present invention. The block division information may include the tree structure information and/or the division type information.

FIG. 7(c) is a diagram illustrating an example of block division information on the block division structure shown in FIG. 7(a) by using a tree structure according to another embodiment of the present invention. The block division information may include the tree structure information and/or the division type information.

In FIGS. 7(a), 7(b), and 7(c), division of the block according to QT intersection division is designated by the solid line, and division of the block according to BT vertical 1:1 and/or BT horizontal 1:1 division is designated by the dotted line.

As shown in FIG. 7(a), a basic block (depth=0) 700 is divided into four sub blocks (depth=1) in the same size using QT intersection division. Here, the depth of each block may mean the depth of each block in the tree structure by division according to the tree structure. Each of the four sub blocks (depth=1) may be further divided using QT intersection division. The sub block on which no further division according to QT intersection division is performed corresponds to the leaf node in the quad tree structure. The leaf node of the quad tree may be the root node of the binary tree. With respect to the root node of the binary tree, division according to the binary tree structure (BT vertical 1:1 and/or BT horizontal 1:1 division) may be performed. Alternatively, division according to the binary tree structure may not be performed. When division according to the binary tree structure is not performed on the leaf node of the quad tree, the leaf node is determined as the coding unit.

As described above, division according to the binary tree structure may be further performed on the leaf node of the quad tree. That is, the leaf node of the quad tree may be the root node of the binary tree. For example, in FIG. 7(a), with respect to the sub block (depth=1) 701 positioned on the lower right side among the four sub blocks resulting from the division of the basic block (depth=0) 700, no further division according to the quad tree structure is performed. The sub block (depth=1) 701 on the lower right side is the root node of the binary tree, on which division according to the binary tree structure may be performed. As described in FIG. 7(a), the sub block (depth=1) 701 on the lower right side is subjected to BT vertical 1:1 division and is divided into two sub blocks (depth=2). Also, the sub block (depth=2) 701-1 positioned on the left among the two sub blocks is subjected to BT vertical 1:1 division and is divided into two sub blocks (depth=3) 701-1a and 701-1b. Each of the two sub blocks (depth=3) 701-la and 701-1b corresponds to the leaf node of the binary tree. Each of the two sub blocks (depth=3) 701-la and 701-1b that are no further divided may be determined as the coding unit.

As described above, according to the present invention, the basic block 700 may be divided using the quad tree structure (QT intersection division) as the main division structure and using the binary tree structures (BT vertical 1:1 division and/or BT horizontal 1:1 division) as the sub division structures. Here, the basic block 700 may be determined as the root node of the quad tree. The root node of the quad tree may be divided using the quad tree structure in a recursive or hierarchical manner before reaching the leaf node of the quad tree. The leaf node of the quad tree may be the root node of the binary tree. The root node of the binary tree may be divided using the binary tree structure in a recursive or hierarchical manner before reaching the leaf node of the binary tree. When the current block is no further divided including division according to the quad tree structure and/or division according to the binary tree structure, the current block is determined as the coding unit.

FIG. 7(b) is a diagram illustrating the block division information for encoding/decoding the block division structure shown in FIG. 7(a) according to an embodiment of the present invention. The block division information may consist of a combination of the tree structure information and/or the division type information.

In the tree structures in FIGS. 7(b) and 7(c), the reference numerals in the parentheses are the reference numerals of the blocks shown in FIG. 7(a), and the information expressed by 0 and/or 1 indicates an example of the block division information with respect to the corresponding block.

Hereinafter, information indicating whether the block is divided according to the quad tree structure is referred to as “quad division information”. The quad division information may be encoded in a first bit length. The first bit length may be one bit. When the current block is divided according to the quad tree structure, the quad division information of the current block is encoded into “1”. When the current block is not divided according to the quad tree structure, the quad division information is encoded into “0”. That is, whether the current block is divided according to the quad tree structure may be encoded into the quad division information of one bit.

Hereinafter, the block division information according to the binary tree structure is referred to as “binary division information”. The binary division information may include at least one among information indicating whether the block is divided according to the binary tree structure and information on the division direction according to the binary tree structure. The binary division information may be encoded in a second bit length. The second bit length may be one bit or two bits. When the current block is the division target according to the binary tree structure, the binary division information of two bits is used as described later. When the current block is divided according to the binary tree structure, the first bit of the binary division information of two bits is encoded into “1”. When the current block is not divided using the binary tree structure, the first bit of the binary division information of two bits is encoded into “0”. According to the block division embodiment in FIG. 7, the block division type according to the binary tree structure includes BT vertical 1:1 division and BT horizontal 1:1 division. Accordingly, information on the division direction (or division type) may be additionally encoded. That is, when division according to the binary tree structure is BT horizontal 1:1 division, the second bit of the binary division information of two bits is encoded into “0”. When division according to the binary tree structure is BT vertical 1:1 division, the second bit of the binary division information of two bits is encoded into “1”. When division according to the binary tree structure is not performed with respect to the current block, the second bit of the binary division information of two bits is not used.

The first bit length and the second bit length may be the same, and no limitation to the embodiment is imposed. Further, in the embodiment, the meaning of the bit values of the quad division information and of the binary division information may be defined reversely. For example, “0” is used for the first bit of the quad division information and/or of the binary division information to indicate that division according to the relevant structure is performed, and “1” is used to indicate that division is not performed. Alternatively, the case where the second bit of the binary division information is “0” is defined as vertical direction division, and “1” is defined as horizontal direction division.

The block division information of the current block may be encoded as shown in Table below using the quad division information in the first bit length and the binary division information in the second bit length together.

TABLE 1

| Quad division | Binary division | Block division | |
|---|---|---|---|
| information | information | information | Meaning |
| 0 | 0 | 00 | Division according to |
| | | | a quad tree structure |
| | | | and a binary tree |
| | | | structure is not |
| | | | performed on a |
| | | | current block |
| 0 | 10 | 010 | BT horizontal 1:1 |
| | | | division is performed |
| | | | on a current block |
| 0 | 11 | 011 | BT vertical 1:1 |
| | | | division is performed |
| | | | on a current block |
| 1 | — | 1 | Division according to |
| | | | a quad tree structure |
| | | | is performed on a |
| | | | current block |
| — | 0 | 0 | Division according to |
| | | | a binary tree |
| | | | structure is not |
| | | | performed on a |
| | | | current block |
| | | | obtained by division |
| | | | using the binary tree |
| | | | structure as a sub |
| | | | division structure |
| — | 10 | 10 | BT horizontal 1:1 |
| | | | division is performed |
| | | | on a current block |
| | | | obtained by division |
| | | | using a binary tree |
| | | | structure as a sub |
| | | | division structure |
| — | 11 | 11 | BT vertical 1:1 |
| | | | division is performed |
| | | | on a current block |
| | | | obtained by division |
| | | | using a binary tree |
| | | | structure as a sub |
| | | | division structure |

In Table 1, the quad division information may be encoded into “0” or “1”, and the binary division information may be encoded into “0”, “10”, or “11”. The block division information is information indicating whether the block is divided, the division type (or the tree structure information), and the division direction (or the division type information), and may be information that the quad division information is combined with the binary division information or information meaning a combination of the quad division information and the binary division information. In Table 1, the first bit of the quad division information and/or the binary division information may correspond to the above-described tree structure information. In Table 1, the second bit of the binary division information may correspond to the above-described division type information. In the embodiment shown in FIG. 7, the type according to quad tree division includes only QT intersection division, such that the division type information may not be required. In the embodiment shown in FIG. 7, the type according to binary tree division includes two types of BT vertical 1:1 and BT horizontal 1:1 division, such that the division type information for distinguishing the two types may be required. Here, the division type information may be, for example, in the length of one bit.

In Table 1, the block division information “00” means that with respect to the current block, division according to the quad tree structure and division according to the binary tree structure are not performed. The block division information “010” means that with respect to the current block, division according to the quad tree structure is not performed (the first bit=0), division according to the binary tree structure is performed (the second bit=1), and division according to the binary tree structure is BT horizontal 1:1 division (the third bit=0). The block division information “011” means that with respect to the current block, division according to the quad tree structure is not performed (the first bit=0), division according to the binary tree structure is performed (the second bit=1), and division according to the binary tree structure is BT vertical 1:1 division (the third bit=1). The block division information “1” means that with respect to the current block, division according to the quad tree structure is performed.

In Table 1, in the case where the quad tree structure is used as the main division structure and the binary tree structure is used as the sub division structure, once with respect to the block resulting from the division according to the quad tree structure, division according to the binary tree structure is performed, division according to quad tree structure is not performed again. Therefore, with respect to the block obtained from division according to the binary tree structure, it is no longer necessary to encode/decoding the quad division information indicating whether division according to the quad tree structure is performed. In this case, the block division information of the block obtained from division according to the binary tree structure may include only the binary division information. That is, without the quad division information, the binary division information may be intactly used as the block division information, and the block division information “10” means that with respect to the current block, division according to the binary tree structure is performed (the first bit=1) and division according to the binary tree structure is BT horizontal 1:1 division (the second bit=0). The block division information “11” means that with respect to the current block, division according to the binary tree structure is performed (the first bit=1) and division according to the binary tree structure is BT vertical 1:1 division (the second bit=1). The block division information “0” means that with respect to the current block obtained from division according to the binary tree structure, division according to the binary tree structure is not further performed.

FIG. 7(b) is a diagram illustrating, in a tree structure, the block division information on the block division structure shown in FIG. 7(a) using a method of encoding the block division information in Table 1. The depth of the tree structure corresponds to the depth of the block division structure in FIG. 7(a). The information shown in each node in FIG. 7(b) means the block division information of the block corresponding to the node. For example, “1” shown in the root node in FIG. 7(b) is the block division information of the block corresponding to the node, namely, the basic block 700 in FIG. 7(a), and indicates that the basic block 700 is subject to QT intersection division according to the quad tree structure and is divided into four sub blocks. When one node has multiple child nodes, the order of arranging the child nodes in FIG. 7(b) complies with raster scan order (or z scan order) in the block division structure shown in FIG. 7(a). That is, when the basic block (depth=0) 700 in FIG. 7(a) is divided into four sub blocks (depth=1) according to the quad tree structure, for example, the sub block (depth=1) 701 on the lower right side is positioned at the end of the four sub blocks (depth=1) in the raster scan order. Therefore, “011”, which is shown at the position of the node at the end among the child nodes that are at the depth of 1 in the tree structure in FIG. 7(b), corresponds to the block division information of the sub block (depth=1) 701 on the lower right side in FIG. 7(a).

The block division information may be, as shown in Table 1, encoded as information in the form of mixing or combining the quad division information and the binary division information. Alternatively, the quad division information and the binary division information may be encoded into separate syntax elements. Also, information indicating whether the block is divided according to the binary tree structure and information on the division direction according to the binary tree structure, which are included in the binary division information, may be encoded separate syntax elements. Alternatively, information indicating whether division takes place according to the quad tree structure or the binary tree structure may be encoded into one syntax element. When division takes place according to the binary tree structure, the division type information is encoded into another syntax element.

FIG. 7(c) is a diagram illustrating the block division information for encoding the block division structure shown in FIG. 7(a) according to another embodiment of the present invention.

According to the embodiment of the present invention, one bit may be required for the quad division information, and two bits may be required for the binary division information. That is, in order to signal the binary division information, information on the division type is additionally required, such that the binary division information may require more bits than the quad division information. In the method of encoding the block division information, which is described with reference to FIG. 7(c), considering the number of bits of the block division information, as shown in Table 2 below, information on whether the division method to be applied to the current block is division according to the quad tree structure or division according to the binary tree structure is encoded.

TABLE 2

| Block division | |
|---|---|
| information | Meaning |
| 0 | Division according to a quad tree structure and |
| | a binary tree structure is not performed on a |
| | current block |
| 1 | Division according to a quad tree structure is |
| | performed on a current block |
| 10 | BT horizontal 1:1 division according to a |
| | binary tree structure is performed on a current |
| | block |
| 11 | BT vertical 1:1 division according to a binary |
| | tree structure is performed on a current block |

In Table 2, the block division information means that with respect to the current block, division according to the quad tree structure and division according to the binary tree structure are not performed. In other words, it means that the current block is a block which is not divided. The block division information “1” means that with respect to the current block, division according to the quad tree structure is performed. The block division information “10” means that with respect to the current block, division according to the binary tree structure is BT horizontal 1:1 division. The block division information “11” means that with respect to the current block, division according to the binary tree structure is BT vertical 1:1 division.

In the method of encoding the block division information in Table 2, the tree structure information (in the embodiment shown in FIG. 7, information indicating which tree structure among the quad tree structure and the binary tree structure is used) is signaled on the basis of the number of bits of the block division information. In the case of one bit, it indicates whether the block is divided and/or that division according to the quad tree structure is performed. In the case of two bits, it indicates that division according to the binary tree structure is performed. Therefore, compared to the method of encoding the block division information in Table 1, the block division information is able to be encoded with a smaller number of bits.

FIG. 7(c) is a diagram illustrating, in a tree structure, the block division information on the block division structure shown in FIG. 7(a) using a method of encoding the block division information in Table 2. In FIGS. 7(b) and 7(c), the tree structures are the same, but different methods of encoding the block division information in Tables 1 and 2 are used, respectively. Therefore, in the description of FIG. 7(b), some thereof, particularly, the description of the arrangement order of the child nodes may be applied to FIG. 7(c) in the same manner.

The method of encoding the block division information is not limited to the methods shown in Tables 1 and 2. For example, the methods in Table 1 and/or Table 2 may be mixed for use or may be partially omitted for use. The block division information may mean all types of information indicating whether the current block is divided, information indicating whether division applied to the current block is quad tree division or binary tree division, and/or information on the division type, for example, BT vertical 1:1 division or BT horizontal 1:1 division, when applying binary tree division.

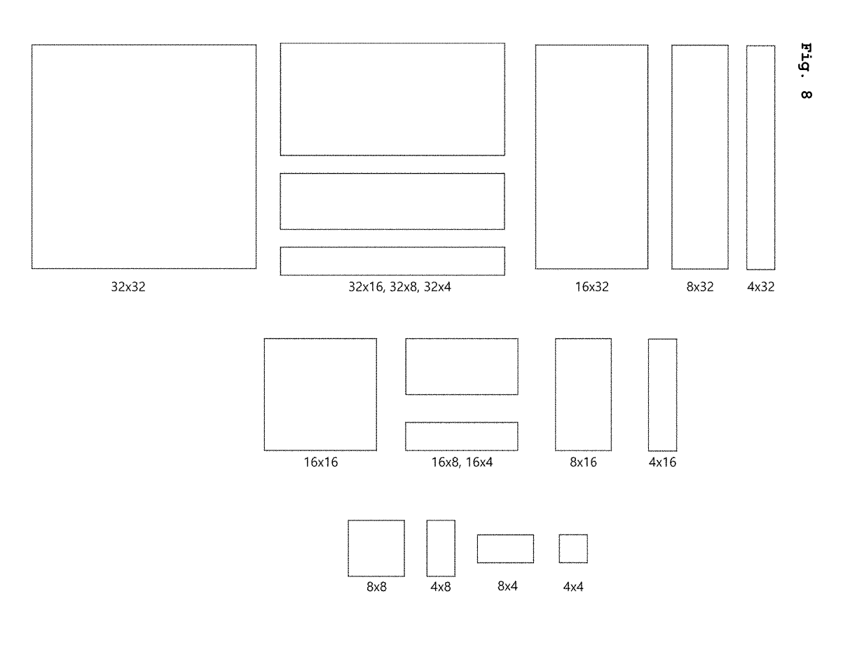

FIG. 8 is a diagram illustrating, when the basic block of the input image is divided into multiple sub blocks according to the quad tree structure and/or the binary tree structure (BT vertical 1:1 division and/or BT horizontal 1:1 division), examples of sizes and shapes of various blocks that the sub blocks resulting from the division may have.

When the coding unit is too small in size, efficient of encoding (prediction, transform, and/or quantization) deteriorates. Also, in consequence of encoding the block division information, the amount of data to be transmitted may increase. Therefore, it is necessary to limit the size of the block that may be divided into smaller blocks. For example, when the length (vertical and/or horizontal) of the block resulting from the division is equal to or smaller than a predetermined value, it is determined that the block is no further divided. The predetermined value may be set to an arbitrary size, such as 4, 8, and 16. The predetermined value may be signaled in the bitstream. The predetermined value may be adaptively signaled on a per-sequence basis, a per-picture basis, a per-slice basis, a per-tile basis, or a per-basic block basis. Alternatively, the predetermined value may be set to a value that is preset by the device for encoding and the device for decoding.

Alternatively, when only one of the vertical and horizontal lengths of the block is equal to or smaller than the predetermined value, division according to the binary tree structure is performed only in one direction. For example, in the case where the horizontal length of the block is equal to or smaller than the predetermined value and corresponds to the size in which no further division takes place, but the vertical length of the block is larger than the predetermined value, it is determined in such a manner that only binary tree division in the horizontal direction is possible. More specifically, when the minimum length in which division is performed on the block is four, only BT horizontal 1:1 division is possible among the types of division according to the binary tree structure with respect to 4×32, 4×16, and 4×8 blocks shown in FIG. 6. Here, since it is found from the sizes of the 4×32, 4×16, and 4×8 blocks that only BT horizontal 1:1 division is possible among the types of division according to the binary tree structure, the block division information is encoded into “10” or When no further division takes place, the block division information is encoded into “0”. Similarly, with respect to 32×4, 16×4, and 8×4 blocks, only BT vertical 1:1 division is possible among the types of division according to the binary tree structure. Here, since it is found from the sizes of the 32×4, 16×4, and 8×4 blocks that only BT vertical 1:1 division is possible among the types of division according to the binary tree structure, the block division information is encoded into “11” or “1”. When no further division takes place, the block division information is encoded into “0”.

Alternatively, the maximum depth at which block division is possible may be limited. For example, when the block is divided in a recursive or hierarchical manner and a predetermined depth is reached, it is determined that the block is no further divided. To the method of setting and encoding the predetermined depth, the method of setting and encoding the minimum size of the block in which the block division is possible may be applied.

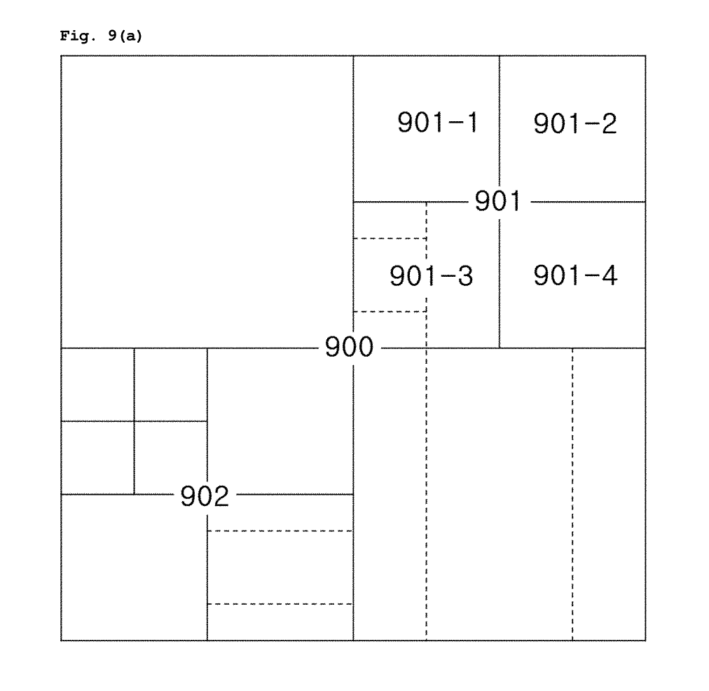

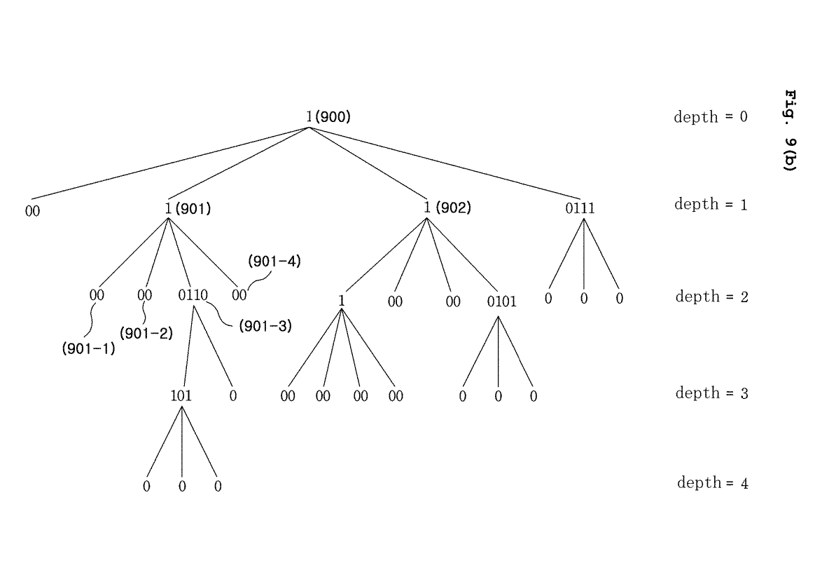

FIG. 9(a) is a diagram illustrating an example of a structure in which a block included in an input image is divided into multiple sub blocks using QT intersection division as a main division structure and using BT vertical 1:1, BT horizontal 1:1, TT horizontal 1:2:1, and/or TT vertical 1:2:1 division as sub division structures. In FIG. 9(a), the reference numeral shown inside the block indicates the relevant block, and the reference numerals shown at the boundaries of the blocks indicate blocks divided by the relevant boundaries.

FIG. 9(b) is a diagram illustrating an example of block division information on the block division structure shown in FIG. 9(a) by using a tree structure according to an embodiment of the present invention. The block division information may include the tree structure information and/or the division type information.

In FIGS. 9(a) and 9(b), division of the block according to QT intersection division is designated by the solid line, and division of the block according to BT vertical 1:1, BT horizontal 1:1, TT horizontal 1:2:1, and/or TT vertical 1:2:1 division is designated by the dotted line.

As shown in FIG. 9(a), a basic block (depth=0) 900 is divided into four sub blocks (depth=1) in the same size using QT intersection division. Here, the depth of each block may mean the depth of each block in the tree structure by division according to the tree structure. Each of the four sub blocks (depth=1) may be further divided using QT intersection division. For example, the block (depth=1) 901 on the upper right side of the basic block (depth=0) 900 and the block (depth=1) 902 on the lower left side may be divided by QT intersection division. The sub block on which no further division according to QT intersection division is performed corresponds to the leaf node of the quad tree. The leaf node of the quad tree may be the root node of the binary tree and/or the triple tree. With respect to the root node of the binary tree and/or the triple tree, division according to the binary tree structure (BT vertical 1:1 and/or BT horizontal 1:1 division) and/or division according to the triple tree structure (TT horizontal 1:2:1 and/or TT vertical 1:2:1 division) may be performed. Alternatively, division according to the binary tree structure and/or the triple tree structure may not be performed. When division according to the binary tree structure and the triple tree structure is not performed on the leaf node of the quad tree, the leaf node is determined as the coding unit.

As described above, division according to the binary tree structure and/or the triple tree structure may be further performed on the leaf node of the quad tree structure. That is, the leaf node of the quad tree may be the root node of the binary tree and/or of the triple tree. For example, in FIG. 9(a), with respect to the sub block (depth=1) 901 positioned on the upper right side among the four sub blocks resulting from the division of the basic block (depth=0) 900, QT intersection division may be performed in a recursive or hierarchical manner. With respect to four sub blocks (depth=2) 901-1 to 901-4 obtained by performing QT intersection division on the sub block (depth=1) 901, QT intersection division may not be further performed. The four sub blocks (depth=2) 901-1 to 901-4 on which QT intersection division is not performed may correspond to the leaf nodes of the quad tree, respectively. Also, the four sub blocks (depth=2) 901-1 to 901-4 may correspond to the root nodes of the binary tree and/or the triple tree, respectively. BT division and/or TT division may not be performed on the blocks 901-1, 901-2, and 901-4 among the four sub blocks. In this case, each of the sub blocks (depth=2) 901-1, 901-2, and 901-4 may be determined as the coding unit.

BT division and/or TT division may be performed on the block 901-3 among the four sub blocks. In FIG. 9(a), the sub block (depth=2) 901-3 is subjected to BT vertical 1:1 division and is divided into two sub blocks (depth=3). With respect to the two sub blocks (depth=3) obtained by the BT vertical 1:1 division, BT division and/or TT division may be performed in a recursive and/or hierarchical manner. For example, according to the example shown in FIG. 9(a), with respect to the block on the left side of the two sub blocks (depth=3) obtained by performing BT vertical 1:1 division on the block (depth=2) 901-3, TT horizontal 1:2:1 division may be performed.

The block may be divided in a hierarchical and/or recursive manner with the above-described method, and the sub block corresponding to the leaf node that is not further divided may be determined as the coding unit.

Whether the block is divided or not may be determined by the device for encoding. The device for encoding may determine whether to divide the block considering characteristics of images, the homogeneous area, complexity of the device for encoding and/or the device for decoding, and/or the number of bits required to signal the block division information. Alternatively, as described above, the minimum size of the block that is no further divided may be predetermined or signaled.

As described above, according to the present invention, the basic block 900 may be divided using the quad tree structure (QT intersection division) as the main division structure and using the binary tree structure and/or the triple tree structure (BT vertical 1:1, BT horizontal 1:1, TT horizontal 1:2:1, and/or TT vertical 1:2:1 division) as the sub division structure. Here, the basic block 900 may be determined as the root node of the quad tree. The root node of the quad tree may be divided using the quad tree in a recursive or hierarchical manner before reaching the leaf node of the quad tree. The leaf node of the quad tree may be the root node of the binary tree and/or of the triple tree. The root node of the binary tree and/or of the triple tree may be divided using the binary tree structure and/or the triple tree structure in a recursive or hierarchical manner before reaching the leaf node. When the current block is no further divided including division according to the quad tree structure, the binary tree structure, and/or the triple tree structure, the current block is determined as the coding unit.

FIG. 9(b) is a diagram illustrating the block division information for encoding/decoding the block division structure shown in FIG. 9(a) according to an embodiment of the present invention. The block division information may consist of a combination of the tree structure information and/or the division type information.

In the tree structure in FIG. 9(b), the reference numerals in the parentheses are the reference numerals of the blocks shown in FIG. 9(a), and the information expressed by 0 and/or 1 indicates an example of the block division information with respect to the corresponding block.

In the following description related to the embodiment in FIG. 9, information indicating whether the block is divided according to the quad tree structure is referred to as “main division information”. The main division information may be encoded in a third bit length. The third bit length may be one bit. When the current block is divided according to the quad tree structure, the main division information of the current block is encoded into “1”. When the current block is not divided according to the quad tree structure, the main division information is encoded into “0”. That is, whether the current block is divided according to the quad tree structure may be encoded into the main division information of one bit.

Hereinafter, the block division information according to the binary tree structure and/or the triple tree structure is referred to as “the sub division information”. The sub division information may include at least one among information indicating whether sub division using the binary tree structure and/or the triple tree structure is performed, information (the tree structure information) indicating which tree structure between the binary tree structure and the triple tree structure is used, and the division type information indicating one block division type among one or more block division types according to each tree structure. The sub division information may be encoded in a fourth bit length. The fourth bit length may be one bit, two bits, or three bits. When the current block is the division target according to the sub division structure, the binary division information of three bits is used as described later. When the current block is divided using the sub division structures (BT vertical 1:1, BT horizontal 1:1, TT horizontal 1:2:1, and/or TT vertical 1:2:1 division) according to the binary tree structure and/or the triple tree structure, the sub division information includes information indicating that sub division is performed, information indicating the tree structure (binary tree or triple tree) used in sub division, and/or information indicating the division type. Each piece of information may be expressed as one bit. When the current block is not divided using the sub division structure, the sub division information is expressed only as one bit, and it is not necessary to transmit information on the tree structure and the division type that are used in sub division. Alternatively, by encoding information specifying one of all division types (for example, BT vertical 1:1, BT horizontal 1:1, TT horizontal 1:2:1, and/or TT vertical 1:2:1 division) used in sub division, information on the tree structure and the division type may be encoded into one syntax element.

The block division information of the current block may be encoded as shown in Tables 3 and 4 below using both the main division information in the third bit length and the sub division information in the fourth bit length. Table 3 shows the block division information that the block included in the main division structure may have. Table 4 shows the block division information that the block included in the sub division structure may have. The block that may be included simultaneously in the main division structure and in the sub division structure may have the block division information in Table 3.

TABLE 3

| Block division | |
|---|---|
| information | Meaning |
| 1 | QT intersection division is performed on a |
| | current block |
| 00 | QT intersection division and sub division (BT |
| | and TT) are not performed on a current block |
| 0100 | QT intersection division is not performed on a |
| | current block, but sub division is performed |
| | Sub division structures are BT, and horizontal |
| | 1:1 division |
| 0101 | QT intersection division is not performed on a |
| | current block, but sub division is performed |
| | Sub division structures are TT, and horizontal |
| | 1:2:1 division |
| 0110 | QT intersection division is not performed on a |
| | current block, but sub division is performed |
| | Sub division structures are BT, and vertical |
| | 1:1 division |
| 0111 | QT intersection division is not performed on a |
| | current block, but sub division is performed |
| | Sub division structures are TT, and vertical |
| | 1:2:1 division |

As shown in Table 3, when main division (QT intersection division) is performed on the current block, it is not necessary to transmit information on sub division. Therefore, the block division information of the block on which main division is performed may be expressed as “1”.

The block division information of the block on which main division is not performed may express information indicating whether main division is performed as “0”. The information indicating whether main division is performed may be, for example, expressed as the first bit of the block division information. However, this is only an embodiment, and all embodiments in which the block division information includes the information indicating whether main division is performed may be covered by the present invention.

The block division information of the block on which main division is not performed may further include information indicating whether sub division is performed. For example, in the embodiment shown in Table 3, the second bit of the block division information is used to indicate whether sub division is performed. However, the embodiment shown in Table 3 is only an embodiment covered by the present invention, and it is not limited thereto.

In the embodiment shown in Table 3, when the block division information of the block is “00”, it is found that the block is a block which is not further divided.

The block division information of the block on which sub division is performed but main division is not performed may include information indicating whether main division is performed and information indicating whether sub division is performed. For example, in the embodiment shown in Table 3, this is expressed using the first two bits of the block division information. That is, by setting the first two bits of the block division information to “01”, expressed is that sub division is performed on the relevant block rather than main division. However, the embodiment shown in Table 3 is only an embodiment covered by the present invention, and it is not limited thereto.

In the case of the block on which sub division is performed, information for specifying whether division takes place in the horizontal direction or in the vertical direction is required and is expressed as the third bit in the embodiment in Table 3. For example, in the case of horizontal division, the third bit of the block division information may be set to “0”, and in the case of vertical division, the third bit of the block division information may be set to “1”. However, the embodiment shown in Table 3 is only an embodiment covered by the present invention, and it is not limited thereto.

In the case of the block on which sub division is performed, information for specifying whether division is BT division or TT division is required and is expressed as the fourth bit in the embodiment in Table 3. For example, in the case of BT division, the fourth bit of the block division information may be set to “0”, and in the case of TT division, the fourth bit of the block division information may be set to “1”.

Alternatively, for example, in the embodiment shown in FIG. 9, there are four division types used in sub division, such as BT vertical 1:1, BT horizontal 1:1, TT horizontal 1:2:1, and/or TT vertical 1:2:1 division, such that the tree structure and the division type may be specified by two bits calculated by ceil(log₂(4)). That is, in this case, it is also found that two bits are used to specify one tree structure and division type, and information assigned for each block division type may correspond to the third and fourth bits of the block division information shown in Table 3.

The embodiment described with reference to Table 3 is only one of various embodiments covered by the present invention, and is not limited thereto. For example, the block division information according to the present invention includes information indicating whether main division is performed, information indicating whether sub division is performed, information for specifying one of multiple sub division structures, and/or information for specifying one of multiple division types. Accordingly, the order in which the information is encoded into the bitstream or the order in which the information appears in the bitstream or is derived from the bitstream is not limited to the embodiment described with reference to Table 3. For example, the positions of the information for specifying one of multiple sub division structures and of the information for specifying one of multiple division types may be switched.

Also, in the present invention, the case where division is performed is not limited to be expressed as “1”, and the case where division is not performed is not limited to be expressed as “0”. These bit values may be assigned reversely for use.

Also, in the present invention, the case of vertical division is not limited to be expressed as “1”, and the case of horizontal division is not limited to be expressed as “0”. These bit values may be assigned reversely for use.

Also, in the embodiments in FIG. 9 and Table 3, the number of division types of each of the BT and the TT is limited to two, but the division types of the BT and/or the TT may include a part or all of various division types described with reference to FIGS. 5 and/or 6. For example, when three or more division types are included, the division type information is expressed as two bits or more.

TABLE 4

| Block division | |
|---|---|
| information | Meaning |
| 0 | Sub division (BT and TT) is not performed on a |
| | current block |
| 100 | Sub division is performed on a current block |
| | Sub division structures are BT, and horizontal |
| | 1:1 division |
| 101 | Sub division is performed on a current block |
| | Sub division structures are TT, and horizontal |
| | 1:2:1 division |
| 110 | Sub division is performed on a current block |
| | Sub division structures are BT, and vertical |
| | 1:1 division |
| 111 | Sub division is performed on a current block |
| | Sub division structures are TT, and vertical |
| | 1:2:1 division |

Table 4 shows an embodiment of the block division information that the block included in the sub division structure may have. The main division (QT intersection division) is not performed on the block included in the sub division structure, such that information indicating whether to perform division according to the main division structure may not be included in the block division information. Accordingly, in the block division information (the block division information in Table 3) that the block included in the main division structure may have, the bits except the first bit of “0” may be the block division information (the block division information in Table 4) that the block included in the sub division structure may have.

The block division information shown in Table 4 is only an embodiment of the block division information according to the present invention, and various embodiments described with reference to Table 3 may be applied to Table 4 in the same manner.

By the method of dividing the block described with reference to FIG. 9, and Tables 3 and 4, when the basic block is divided into multiple sub blocks, each sub block that is no further divided is determined as the coding unit. The size and shape of each sub block determined as the coding unit may be, as described in FIG. 8, the square or rectangle in the 2n×2m size.

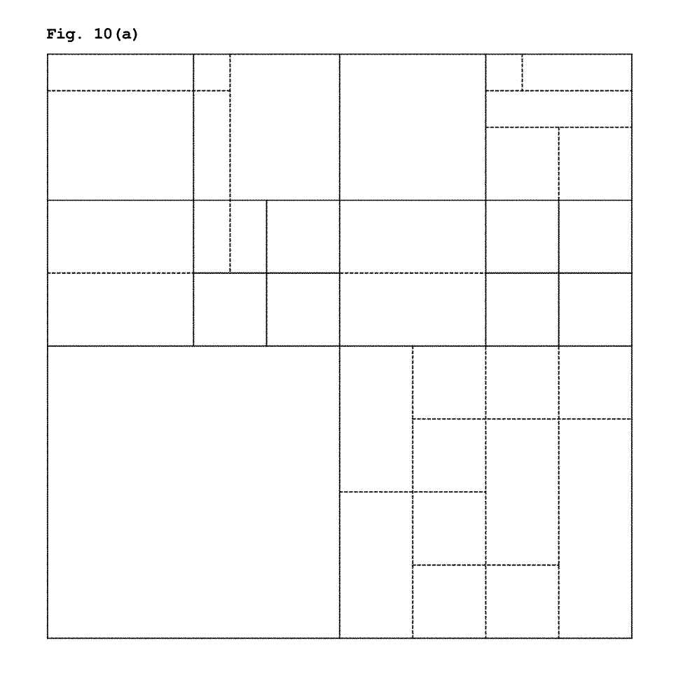

FIG. 10(a) is a diagram illustrating an example of a structure in which a block included in an input image is divided into multiple sub blocks using QT intersection division as a main division structure and using BT vertical 1:1, BT horizontal 1:1, BT horizontal 1:3, BT horizontal 3:1, BT vertical 1:3, and/or BT vertical 3:1 division as sub division structures. In FIG. 10(a), the reference numeral shown inside the block indicates the relevant block, and the reference numerals shown at the boundaries of the blocks indicate blocks divided by the relevant boundaries.

FIG. 10(b) is a diagram illustrating an example of block division information on the block division structure shown in FIG. 10(a) by using a tree structure according to an embodiment of the present invention. The block division information may include the tree structure information and/or the division type information.

In FIGS. 10(a) and 10(b), division of the block according to QT intersection division is designated by the solid line, and division of the block according to BT vertical 1:1, BT horizontal 1:1, BT horizontal 1:3, BT horizontal 3:1, BT vertical 1:3, and/or BT vertical 3:1 division are designated by the dotted line.

The embodiment shown in FIG. 10 is similar to the embodiment shown in FIG. 7 except that BT horizontal 1:3, BT horizontal 3:1, BT vertical 1:3, and/or BT vertical 3:1 division are added to the embodiment in FIG. 7. Also, the embodiment shown in FIG. 10 is similar to the embodiment shown in FIG. 9 except that BT horizontal 1:3, BT horizontal 3:1, BT vertical 1:3, and/or BT vertical 3:1 division are added instead of TT division in FIG. 9. Therefore, in the description of FIG. 10, a description of a part that can be obviously understood from the description of FIGS. 7 and 9 will be omitted.

In the embodiment shown in FIG. 10, the main division information may be encoded in a fifth bit length. The fifth bit length may be one bit. When the current block is divided according to the quad tree structure, the main division information of the current block is encoded into “1”. When the current block is not divided according to the quad tree structure, the main division information is encoded into “0”. That is, whether the current block is divided according to the quad tree structure may be encoded into the main division information of one bit.

In the embodiment shown in FIG. 10, block division information according to BT vertical 1:1, BT horizontal 1:1, BT horizontal 1:3, BT horizontal 3:1, BT vertical 1:3, and/or BT vertical 3:1 division is referred to as “the sub division information”. The sub division information may include at least one among information indicating whether sub division is performed, and information indicating which division type is used among BT vertical 1:1, BT horizontal 1:1, BT horizontal 1:3, BT horizontal 3:1, BT vertical 1:3, and/or BT vertical 3:1 division. The sub division information may be encoded in a sixth bit length. The sixth bit length may be one bit length among one bit to four bits. When the current block is the division target according to the sub division structure, the sub division information of four bits is used as described later. When the block is divided using one among BT vertical 1:1, BT horizontal 1:1, BT horizontal 1:3, BT horizontal 3:1, BT vertical 1:3, and/or BT vertical 3:1 division as the sub division structure, the sub division information includes information indicating sub division is performed and/or the division type information. The division type information may include information indicating the direction (vertical or horizontal) of sub division, information indicating the ratio (1:1 or 1:3) of sub division, and/or information indicating, when the ratio of sub division is 1:3, whether the ratio is 1:3 or 3:1. Each piece of information may be expressed as one bit, for example.

The block division information of the current block may be encoded as shown in Tables 5 and 6 below using both the main division information in the fifth bit length and the sub division information in the sixth bit length. Table 5 shows the block division information that the block included in the main division structure may have. Table 6 shows the block division information that the block included in the sub division structure may have. The block that may be included simultaneously in the main division structure and in the sub division structure may have the block division information in Table 5.

TABLE 5

| Block division | |
|---|---|
| information | Meaning |
| 1 | QT intersection division is performed on a |
| | current block |
| 00 | QT intersection division and BT division are |
| | not performed on a current block |
| 0100 | QT intersection division is not performed on a |
| | current block, but BT division is performed |
| | A direction of BT division is horizontal, and a |
| | ratio is 1:1 |
| 0110 | QT intersection division is not performed on a |
| | current block, but BT division is performed |
| | A direction of BT division is vertical, and a |
| | ratio is 1:1 |
| 01010 | QT intersection division is not performed on a |
| | current block, but BT division is performed |
| | A direction of BT division is horizontal, and a |
| | ratio is 1:3 |
| 01011 | QT intersection division is not performed on a |
| | current block, but BT division is performed |
| | A direction of BT division is horizontal, and a |
| | ratio is 3:1 |
| 01110 | QT intersection division is not performed on a |
| | current block, but BT division is performed |
| | A direction of BT division is vertical, and a |
| | ratio is 1:3 |
| 01111 | QT intersection division is not performed on a |
| | current block, but BT division is performed |
| | A direction of BT division is vertical, and a |
| | ratio is 3:1 |

As shown in Table 5, when main division (QT intersection division) is performed on the current block, it is not necessary to transmit information on sub division. Therefore, the block division information of the block on which main division is performed may be expressed as “1”.

The block division information of the block on which main division is not performed may express information indicating whether main division is performed as “0”. The information indicating whether main division is performed may be, for example, expressed as the first bit of the block division information.

The block division information of the block on which main division is not performed may further include information indicating whether sub division is performed. For example, in the embodiment shown in Table 5, the second bit of the block division information is used to indicate whether sub division is performed. Therefore, when the block division information of the block is “00”, it is found that the block is a block which is not further divided.

The block division information of the block on which sub division is performed but main division is not performed may include information indicating whether main division is performed and information indicating whether sub division is performed. For example, in the embodiment shown in Table 5, this is expressed using the first two bits of the block division information. That is, by setting the first two bits of the block division information to “01”, expressed is that sub division is performed on the relevant block rather than main division.

In the case of the block on which sub division is performed, information on whether division takes place in the horizontal direction or in the vertical direction is required. This may be expressed as the third bit in the embodiment in Table 5. For example, in the case of vertical division, the third bit of the block division information may be set to “1”, and in the case of horizontal division, the third bit of the block division information may be set to Next, information for specifying whether the ratio of horizontal division or vertical division is 1:1 or 1:3 is required. For example, in the embodiment shown in Table 5, in the case of 1:1 division, the fourth bit of the block division information may be set to “0”, and in the case of 1:3 division, the fourth bit of the block division information may be set to “1”.

When the ratio of division is 1:3, information on whether division is 1:3 division or 3:1 division is specifically required. For example, in the embodiment shown in Table 5, in the case of 1:3 division, the fifth bit of the block division information may be set to “0”, and in the case of 3:1 division, the fifth bit of the block division information may be set to “1”.

Alternatively, for example, in the embodiment shown in FIG. 10, there are six division types used in sub division, such as BT vertical 1:1, BT horizontal 1:1, BT horizontal 1:3, BT horizontal 3:1, BT vertical 1:3, and/or BT vertical 3:1 division, such that the tree structure and the division type may be specified by three bits calculated by ceil(log₂(6)). That is, in this case, it is also found that three bits are used to specify one tree structure and division type, and information assigned for each block division type may correspond to the third, fourth, and fifth bits of the block division information shown in Table 5.

The embodiment described with reference to Table 5 is only one of various embodiments covered by the present invention, and is not limited thereto. For example, the block division information according to the present invention includes information indicating whether main division is performed, information indicating whether sub division is performed, and/or information for specifying one of multiple sub division structures. Accordingly, the order in which the information is encoded into the bitstream or the order in which the information appears in the bitstream or is derived from the bitstream is not limited to the embodiment described with reference to Table 5. For example, the positions of the information for specifying the direction of sub division and of the information for specifying the ratio of sub division may be switched.

Also, in the present invention, the case where division is performed is not limited to be expressed as “1”, and the case where division is not performed is not limited to be expressed as “0”. These bit values may be assigned reversely for use.

Also, in the present invention, the case of vertical division is not limited to be expressed as “1”, and the case of horizontal division is not limited to be expressed as “0”. These bit values may be assigned reversely for use.

Also, in the present invention, 1:1 ratio is not limited to be expressed as “0”, and 1:3 ratio is not limited to be expressed as “1”. These bit values may be assigned reversely for use.

Also, in the present invention, 1:3 ratio is not limited to be expressed as “0”, and 3:1 ratio is not limited to be expressed as “1”. These bit values may be assigned reversely for use.

TABLE 6

| Block division | |
|---|---|
| information | Meaning |
| 0 | BT division is not performed on a current block |
| 100 | BT division is performed on a current block |
| | A direction of BT division is horizontal, and a |
| | ratio is 1:1 |
| 110 | BT division is performed on a current block |
| | A direction of BT division is vertical, and a |
| | ratio is 1:1 |
| 1010 | BT division is performed on a current block |
| | A direction of BT division is horizontal, and a |
| | ratio is 1:3 |
| 1011 | BT division is performed on a current block |
| | A direction of BT division is horizontal, and a |
| | ratio is 3:1 |
| 1110 | BT division is performed on a current block |
| | A direction of BT division is vertical, and a |
| | ratio is 1:3 |
| 1111 | BT division is performed on a current block |
| | A direction of BT division is vertical, and a |
| | ratio is 3:1 |

Table 6 shows an embodiment of the block division information that the block included in the sub division structure may have in the embodiment shown in FIG. 10. The main division (QT intersection division) is not performed on the block included in the sub division structure, such that information indicating whether to perform division according to the main division structure may not be included in the block division information. Accordingly, in the block division information (the block division information in Table 5) that the block included in the main division structure may have, the bits except the first bit of “0” may be the block division information (the block division information in Table 6) that the block included in the sub division structure may have.

The block division information shown in Table 6 is only an embodiment of the block division information according to the present invention, and various embodiments described with reference to Table 5 may be applied to Table 6 in the same manner.

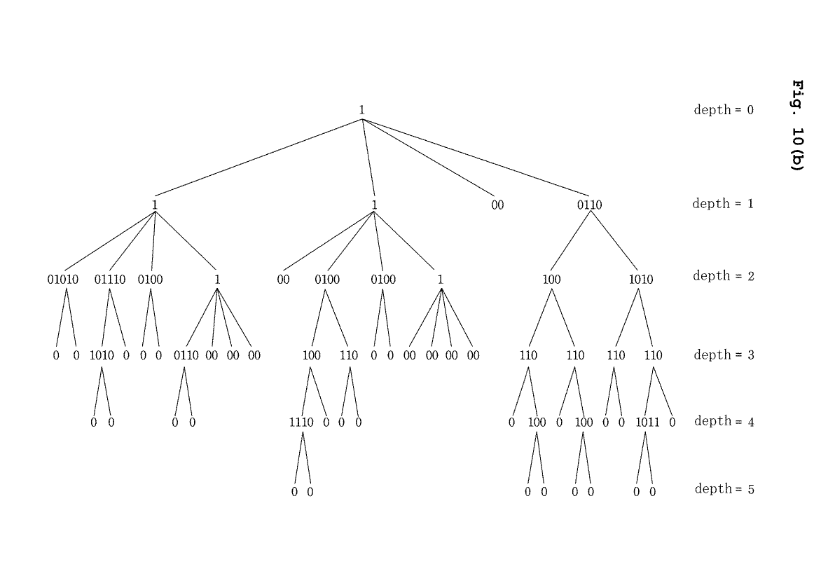

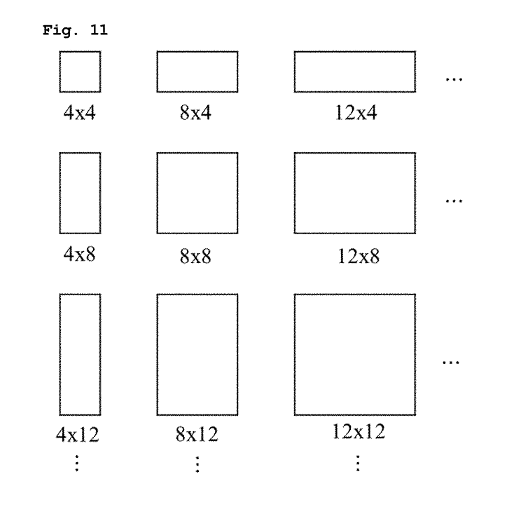

By the method of dividing the block described with reference to FIG. 10, and Tables 5 and 6, when the basic block is divided into multiple sub blocks, each sub block that is no further divided is determined as the coding unit. The coding unit determined according to the embodiment described with reference to FIG. 10 may be the square or rectangle in the 2n×2m (n and m are integers larger than one) size. Assuming that the minimum division size in which division is possible is 4×4, the coding units having the horizontal or vertical length of 4×4, 8×4, 4×8, 12×4, and the like rather than 2ⁿ may be generated as described in FIG. 11.

In the division method described with reference to FIG. 7, QT intersection division is used as the main division structure, and BT vertical 1:1 and/or BT horizontal 1:1 division is used as the sub division structure. In the division method described with reference to FIG. 9, QT intersection division is used as the main division structure, and BT vertical 1:1, BT horizontal 1:1, TT vertical 1:2:1, and/or TT horizontal 1:2:1 division are used as the sub division structures. In the division method described with reference to FIG. 11, QT intersection division is used as the main division structure, and BT vertical 1:1, BT horizontal 1:1, BT horizontal 1:3, BT horizontal 3:1, BT vertical 1:3, and/or BT vertical 3:1 division are used as the sub division structures. Hereinafter, the method of dividing the block using the main division structure and the sub division structure based on the QT, BT, and/or TT will be described more generally, and information and the number of bits that are required to be included in the block division information will be described.

As shown in FIGS. 4 to 6, division according to the QT may include three division types. Division according to the BT may include six division types. Division according to the TT may also include six division types. However, these are only the division types based on the examples shown in FIGS. 4 to 6, and the number of division types is not limited thereto. For example, when then ratio is variously set, the number of division types of the QT, BT, and TT increases. For example, it is possible to set division types of various ratios, such as BT 1:4, BT 1:5, BT 2:5, TT 1:3:1, TT 1:4:1, TT 1:2:2.

There are 15 division types shown in FIGS. 4 to 6, and one division type thereof may be used as the main division structure. For example, QT intersection division may be used as the main division structure, but the main division structure is not limited to QT intersection division.

When QT intersection division is used as the main division structure, all or a part of the remaining 14 division types is used as the sub division structure.

Information on which division type is used as the main division structure and/or on division type is used as the sub division structure may be transmitted through at least one among a sequence, a picture, a slice, a tile, and a basic block as described above. Alternatively, it may be predetermined in the information the device for encoding and the device for decoding. Alternatively, it may be derived on the basis of an encoding parameter and/or an internal variable derived from the encoding/decoding process.

In order to indicate whether division according to the main division structure is performed, as described above, for example, one bit may be used.

In order to indicate whether division according to the sub division structure is performed, as described above, for example, one bit may be used.

Assuming that the number of division types used in the sub division structure is n, information indicating which division type is used among n available division types may be expressed by ceil(log₂(n)). Here, ceil( ) means a raising function.

Accordingly, the block division information of the block included in the main division structure may include information indicating whether main division is performed (for example, information of one bit), information indicating, when main division is not performed, whether sub division is performed (for example, information of one bit), and/or information indicating, when sub division is performed, one among n available division types (for example, information of ceil(log₂(n)) bits). This may be expressed as Table 7 below.

TABLE 7

| Block division | |
|---|---|
| information | Meaning |
| 1 | Main division is performed on a current |
| | block |
| 00 | Main division and sub division are not |
| | performed on a current block |
| 01 + ceil(log₂(n)) | Main division is not performed on a |
| bits | current block, but sub division is |
| | performed |
| | Sub division structure to be applied to |
| | a current block is specified |
| | information of ceil(log₂(n)) bits |

In the meantime, the block division information of the block included in the sub division structure includes information indicating whether sub division is performed (for example, information of one bit) and/or information indicating, when sub division is performed, one among n available division types (for example, information of ceil(log₂(n)) bits). This may be expressed as Table 8 below.

TABLE 8

| Block division | |
|---|---|
| information | Meaning |
| 0 | Sub division is not performed on a |
| | current block |
| 1 + ceil(log₂(n)) | Sub division is performed on a current |
| bits | block |
| | Sub division structure to be applied to a |
| | current block is specified by information |
| | of ceil (log₂(n)) bits |

The various embodiments described with reference to FIGS. 7 to 11 may be applied to the general division method according to the main division structure and/or the sub division structure. Also, as another embodiment of the division method according to the main division structure and/or the sub division structure, it is possible to limit the number of times that main division is applied, the depth, and/or the size of the block (the maximum size and/or the minimum size). Alternatively, it is possible to limit the number of times that sub division is applied, the depth, and/or the size of the block (the maximum size and/or the minimum size). For example, it is limited in such a manner that main division is applied only once at the beginning, and then only sub division is possible. Alternatively, it is limited in such a manner that main division is applied multiple times and sub division is applied only once. Alternatively, it is limited in such a manner than main division is applied only n times and sub division is applied only m times. Here, n and m may be integers or one or more. Information on the additional limitations of main division and sub division may be transmitted in units of at least one among a sequence, a picture, a slice, a tile, and a basic block. Alternatively, the information on the additional limitations may be preset in the device for encoding and in the device for decoding. Alternatively, the information on the additional limitations may be determined by the encoding parameter and/or the internal variable used in the encoding/decoding process.

The encoding parameter and/or the internal variable may include information on the size of the block, information on the division depth of the block, information on luma components and/or chroma components, information on the inter mode, information on the intra mode, an encoding block flag, a quantization parameter, a motion vector, information on a reference image, and/or information on whether encoding is performed in a PCM mode. Also, the encoding parameter and/or the internal variable may include things related to the current block as well as to nearby blocks.

Division methods of hierarchically dividing the block using the tree structure includes a division method in which main division/sub division is distinguished and a division method in which main division/sub division is not distinguished.

The division method in which main division/sub division is distinguished may be defined as a multi-division hierarchy method. For example, the various division methods described with reference to FIGS. 7 to 11 may correspond thereto. According to the multi-division hierarchy method, one division structure may be determined as the main division structure, and one or more division structures may be determined as the sub division structures. Multiple division structures may preset as sub division structures, and sub division using different tree structures is possible. For example, the sub division structure using the BT and/or the TT is possible. Here, the BT and the TT may be used as the sub division structures in any order. That is, after division using the BT is performed, division using the TT may be performed, and division using the BT may be performed again. Alternatively, there may be an application order of the BT and the TT. For example, with respect to the leaf node of the main division structure, the BT may be applied first, and with respect to the leaf node of the sub division structure using the BT, the TT may be applied. Here, with respect to the leaf node of the main division structure, when sub division using the BT is not performed, sub division using the TT is applied.

The division method in which main division/sub division is not distinguished may be defined as a single division hierarchy method. For example, a part or all of the various division types described with reference to FIGS. 4 to 6 may be used as the division structure of the block in any order. In the case of the single division hierarchy method where n division types are used, one to ceil(log₂(n))+1 bits may be used to indicate the block division information of each node of the tree structure. Therefore, generally, when using the single division hierarchy method, the number of bits required to encode the block division information increases, compared to using the multi-division hierarchy method.

Various methods of dividing the block and various embodiment of encoding the block division information have been described. In the embodiments, information to be transmitted from the device for encoding to the device for decoding may be transmitted via at least one level among a sequence level, a picture level, a slice level, a tile level, and a basic block level. Information to be encoded may include information on whether the single division hierarchy method or the multi-division method is applied. Also, the information to be encoded may include information on the division type that may be used as the main division structure and/or information on the division type that may be used as the sub division structure. Also, the information to be encoded may include information on the number of times that main division and/or sub division is possible/the depth/the size of the block, and the like. The information to be encoded may be preset in the device for encoding and in the device for decoding. Alternatively, theses pieces of information may be derived by other encoding parameters or internal variables.

As described above, by dividing the basic block according to the division structures including the quad tree structure, the binary tree structure, and/or the triple tree structure, multiple sub blocks that are not further divided may be determined. The sub block that is no further divided is determined as the coding unit and may be a unit of prediction, transform, and/or quantization. At an encoding step, inter prediction or intra prediction is performed on each coding unit to obtain a prediction signal. A residual signal may be calculated from the difference between the obtained prediction signal and the original signal of the coding unit. With respect to the calculated residual signal, transform may be performed for energy concentration.

The coding unit according to the present invention is in the shape of the rectangle or square in various sizes of 4×4, 4×8, 8×4, 8×8, 16×4, 4×16, and the like, such that in order to transform the residual signal of the coding unit according to the present invention, it is necessary to define square shape transform as well as non-square shape transform. The Equation used in transform is as follows.

Y=AXB^{T} [Equation 1]

X denotes a two-dimensional residual signal block in an m×n size, A denotes one-dimensional n-point transform in the horizontal direction, and BT denotes one-dimensional m-point transform in the vertical direction. BT denotes a transposed matrix of B. m and n may be different in size or may be the same in size. Further, A and B may be the same transform basis or may be different transform bases. denotes a transform block obtained by transforming the residual signal block X.

The Equation used in the process of inverse transforming the transform block Y is as follows.

X=A^{T}YB [Equation 2]

In Equations 1 and 2, vertical direction transform and horizontal direction transform may obtain similar results regardless of the execution order. However, when the expression range of transform coefficients has limited bit precision, such as 16 bits, the execution order of vertical direction transform and horizontal direction transform is required to be the same in the device for encoding and in the device for decoding. This is because data is discarded in the middle of operation due to the limited bit precision. In order to prevent a mismatch that may happen in the device for encoding/the device for decoding, vertical direction transform and horizontal direction transform are required to be performed in the same order in the device for encoding/the device for decoding.

In order for the transform equation in Equation 1 and the inverse transform in Equation 2 to be established, transform bases are required to satisfy separability and orthogonality. This limitation is necessary because the amount of calculation decreases from O(n⁴) to O(n³) and satisfies A^{τ}=A⁻¹.

Types of bases (basis vectors, and kernel) that may be used as transform bases (transform basis vectors) include discrete cosine transform type-II (DCT-II), DCT-V, DCT-VIII, discrete sine transform type-I (DST-I), DST-VII, and the like. In practice, for calculation speed and accuracy of calculation, the device for encoding/the device for decoding approximates the transform bases to integers for use.

When the coding unit is in the size of m×n, one-dimensional n-point transform and one-dimensional m-point transform are necessary according to separability. Equation 3 below is an example of a one-dimensional DCT-II transform basis that may be applied with respect to all sizes of the coding unit in the case of 4<=m, n<=64.

[Equation 3]

$$cos ( \frac{π * ( i + 0.5 ) * v}{N} ) * {w}_{0} ; \{ \begin{matrix}{w}_{0} = \sqrt{\frac{1}{N}} , when v = 0 \\ {w}_{0} = \sqrt{\frac{2}{N}} , when v \neq 0\end{matrix}$$

For use in transform in the device for encoding/the device for decoding, each of the elements of the transform basis, which have real number values, is multiplied by \sqrt{N}*K and the result is rounded off to an integer, thereby generating an integer transform basis. FIG. 12 is a diagram illustrating examples of real number bases of DCT-II that may be used in transform and integer bases that are obtained multiplying real number bases by predetermined values. FIG. 12 shows integer transform bases obtained by applying 64 as the K value. As the K value increases, accuracy of transform is enhanced. However, the memory usage of the device for encoding/the device for decoding may also increase. Therefore, the K value is selected according to the situation. Conversely, in inverse transform, division by \sqrt{N}*K takes place. In order to reduce the amount of calculating using shift operation, K=2^{K} (K is an integer larger than one) may be used.

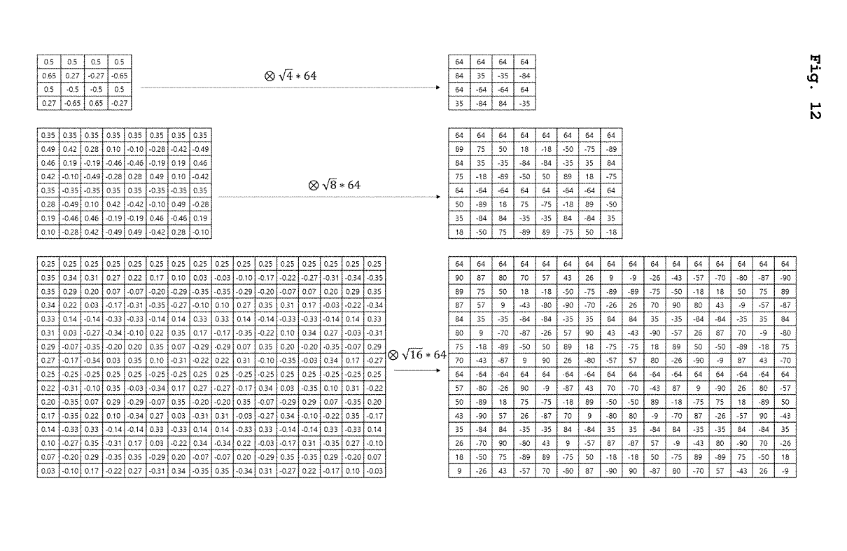

FIG. 13 is a diagram illustrating examples of real number transform bases of DST-VII that may be used in transform and integer transform bases that are obtained multiplying real number transform bases by predetermined values. As described above with reference to FIG. 12, when the coding unit is in the size of m×n, one-dimensional n-point transform and one-dimensional m-point transform are necessary. As shown in FIG. 13, in the case of 4<=m, n<=64, one-dimensional DST transform may be applied with respect to the coding units in all sizes.

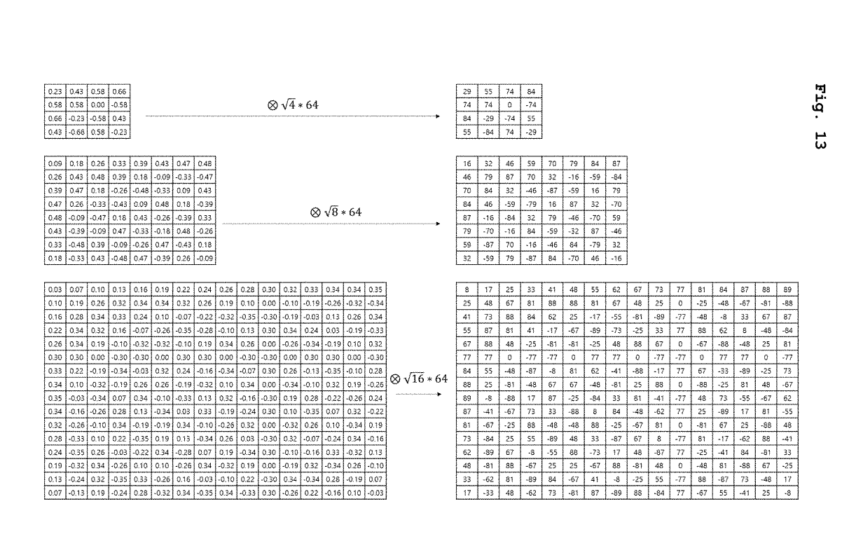

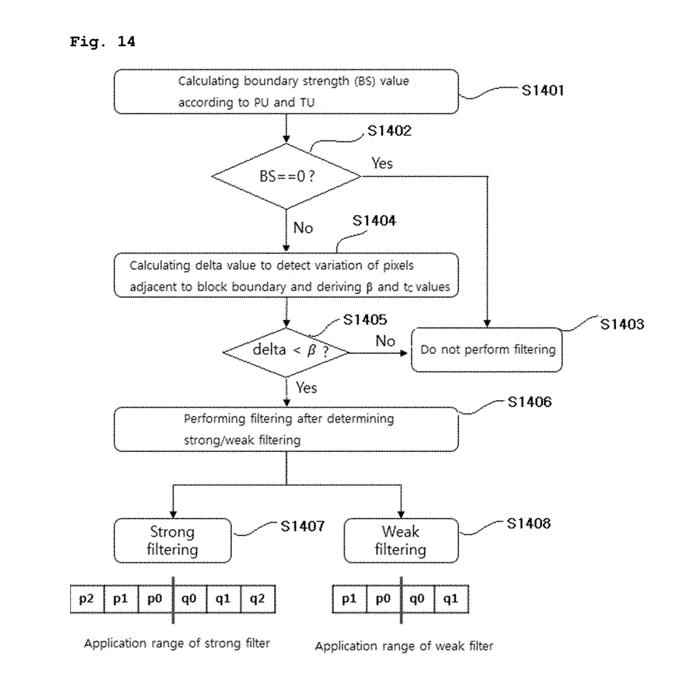

FIG. 14 is a flowchart illustrating in-loop filtering according to an embodiment of the present invention. An in-loop filter may include at least one of the deblocking filter, the offset correction module, and the adaptive loop filter (ALF). Alternatively, examples of the in-loop filtering may include filtering applied to a reconstruction sample and/or a prediction sample.

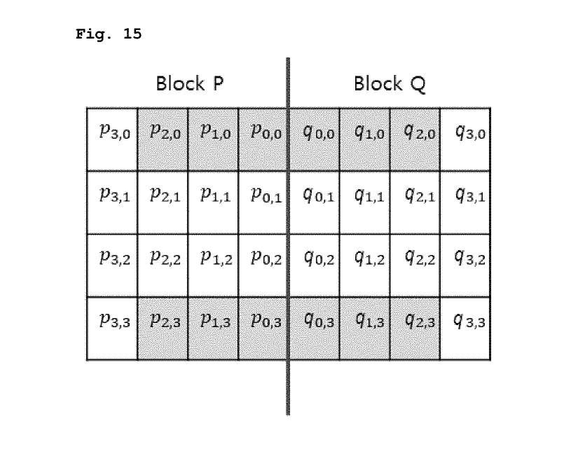

FIG. 15 is a diagram illustrating two blocks adjacent to a block boundary and pixels therein that are used to perform in-loop filtering according to FIG. 14.

In-loop filtering may be a method for reducing blocking artifacts that occur in the block boundary due to transform and quantization process performed on a per-block basis. In in-loop filtering, horizontal direction filtering (horizontal filtering) is performed on a vertical block boundary in an arbitrary size or more, and then vertical direction filtering (vertical filtering) is performed on a horizontal block boundary. Alternatively, after performing vertical direction filtering, horizontal direction filtering may be performed. The result of filtering that is performed first is the input of the subsequent filtering to be performed, such that the order of filtering is required to be the same in the device for encoding/the device for decoding. When the order of filtering is not the same, the mismatch between filtered pixel values occurs in encoding/decoding.

An arbitrary size in which in-loop filtering is applied may be preset in the device for encoding/the device for decoding or may be determined from the information signaled in the bitstream. For example, the arbitrary size may be a size of 4×4, 8×8, 16×16, and the like, and the horizontal and vertical lengths may be determined differently.

In-loop filtering may be selectively performed, and whether to perform in-loop filtering may be determined previously. For example, whether to perform filtering may be determined on the basis of at least one among information indicating whether to perform filtering, a boundary strength (BS) value, and at least one variable value that is related to a variation of pixels adjacent to the block boundary. The information indicating whether to perform filtering may be signaled via at least one among a sequence, a picture, a slice, a tile, and a block level.

According to the method shown in FIG. 14, in order to determine whether to perform filtering, encoding information of at least one block adjacent to the block boundary to be filtered may be used. Here, the encoding information may include the prediction mode of the block, motion information, and/or a transform coefficient.

At step S1401, with respect to the boundary of the prediction unit (PU) and/or transform unit (TU), a boundary strength (BS) value, which means the strength of the block boundary, is calculated at step S1401. The prediction unit and/or the transform unit mean types of two blocks adjacent to the block boundary, and the type of block used in calculating the BS value is not limited thereto. For example, as described later, the BS value with respect to the boundary of the coding unit (CU) may be calculated.

For example, when at least one block among the two blocks adjacent to the block boundary is encoded in an intra prediction mode, the BS value may be determined as a first value. The first value may be determined as, for example, a constant of two or more. When both the two blocks adjacent to the block boundary are encoded in an inter prediction mode, the BS value may be a second value depending on motion vector values of the two blocks, the number of motion vectors, whether reference pictures are the same, and/or whether at least one block among the two blocks has a quantized residual signal coefficient rather than zero. The second value may be a constant (for example, zero, one, and the like) smaller than the first value. The BS value is not limited to the first value and the second value, and, for example, by subdividing the criterion for determining the BS value, the BS value may have a value of various stages, such as a third value, a fourth value, and the like. Hereinafter, the embodiment in which the BS value has one value among zero, one, and two will be described as a standard. However, as described above, the BS value may have more values than that, and thus no limitation to the following embodiment is imposed.

At step S1402, whether the BS value is zero or not may be determined. When the BS value is zero, filtering may not be performed at step S1403.

When the BS value is not zero, step S1404 is performed. At step S1404, a delta value for measuring the pixel variation of pixels adjacent to the block boundary may be calculated. The delta value may be calculated on a per-predetermined block basis. Here, all or some lines (rows or columns) that belong to the predetermined block basis may be used. The positions and/or the number of some lines may be pre-established and fixed in the device for encoding/the device for decoding, or may be variably determined depending on the size/shape of the block. Also, one or more pixels positioned on the line may be used. Here, multiple pixels may be continuously arranged or may be non-continuous pixels spaced apart from each other at predetermined intervals. For example, the delta value may be calculated on a per-4×4 block basis by the variation of the pixels in the bright gray colored area inside the block in FIG. 15.

In FIG. 15, the thick vertical line in the center denotes the boundary between the left block P and the right block Q. Each square of the grid inside the block P and the block Q represents one pixel. A sign shown inside each square of the grid is an index used to indicate a pixel corresponding to the relevant square.

The delta value may be calculated on the basis of variation of brightness values of the pixels near the block boundary. The variation of brightness values of the pixels near the block boundary may be calculated on the basis of variation of brightness values of pixels that are positioned on the left side and/or the right side (or the upper side and/or the lower side) with the block boundary in the center. For example, the delta value may be calculated, using pixels of the block P and the block Q shown in FIG. 15, according to Equation 4 below. Equation 4 may be an equation for calculating the strength of the edge at the relevant block boundary.

dp0=abs(p2,0−2*p1,0+p0,0)

dp3=abs(p2,3−2*p1,3+p0,3)

dp0=abs(p2,0−2*q1,0+q0,0)

dp0=abs(q2,3−2*q1,3+q0,3)

dp=dp0+dp3

dq=dq0+dq3

dpq0=dp0+dq0

dpq3=dp3+dq3

delta=dpq0+dpq3 [Equation 4]

Also, at step S1404, two threshold values, beta ((3) value and t_{c} value, may be derived. The beta value and the t_{c} value may be derived on the basis of a quantization parameter (QP) and Table 9 below. The quantization parameter may be derived from a parameter that is related to quantization of two blocks or at least one block of the two blocks adjacent to the block boundary. Q in Table 9 is a value derived from the quantization parameter. When the Q value is determined from the quantization parameter, β′ and t_{c}′ values are determined with reference to Table 9. The beta value and the t_{c} values may be determined on the basis of the determined v and t_{c}′ values.

TABLE 9

| | Q | | | | | | | | | | | | | | | | | | |
|---|---|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 16 | 17 | 18 |
| β′ | 0 | 0 | 0 | 0 | 0 | 0 | 0 | 0 | 0 | 0 | 0 | 0 | 9 | 0 | 0 | 0 | 6 | 7 | 8 |
| t_{c}′ | 0 | 0 | 0 | 0 | 0 | 0 | 0 | 0 | 0 | 0 | 0 | 0 | 9 | 0 | 0 | 0 | 9 | 0 | 1 |
| | Q | | | | | | | | | | | | | | | | | | |
| | 19 | 20 | 21 | 22 | 23 | 24 | 25 | 26 | 27 | 28 | 29 | 30 | 31 | 32 | 33 | 34 | 35 | 36 | 37 |
| β′ | 9 | 10 | 11 | 12 | 13 | 14 | 15 | 16 | 17 | 18 | 20 | 22 | 24 | 26 | 28 | 30 | 32 | 34 | 36 |
| t_{c}′ | 1 | 1 | 1 | 1 | 1 | 1 | 1 | 1 | 2 | 2 | 2 | 2 | 3 | 3 | 3 | 3 | 4 | 4 | 4 |

| | Q | | | | | | | | | | | | | | | |
|---|---|---|---|---|---|---|---|---|---|---|---|---|---|---|---|---|
| | 38 | 39 | 40 | 41 | 42 | 43 | 44 | 45 | 46 | 47 | 48 | 49 | 50 | 51 | 52 | 53 |
| β′ | 38 | 40 | 42 | 44 | 46 | 48 | 50 | 52 | 54 | 56 | 58 | 60 | 62 | 64 | — | — |
| t_{c}′ | 5 | 5 | 6 | 6 | 7 | 8 | 9 | 10 | 11 | 13 | 14 | 16 | 18 | 20 | 22 | 24 |

The beta value and/or the t_{c} values may be used to determine whether to perform filtering. Also, when determining that filtering is performed, the beta value and/or the t_{c} value are used to select the filtering type. The filtering type varies according to the range of pixels to which filtering is applied, filtering strength, and the like. For example, filtering types include strong filtering and weak filtering. However, the filtering types are not limited thereto. For example, three or more filtering types with different filtering strengths may be provided.

Alternatively, as described later, when different filtering is applied according to the shapes, sizes, and/or characteristics of two blocks adjacent to the block boundary, each filtering is set as an individual filtering type. Also, when performing filtering, the beta value and/or the t_{c} value are used for clipping of the filtered pixel.

At step S1405, the delta value may be compared with the beta value. On the basis of the result of comparison at step S1405, whether to perform filtering may be determined. When the delta value is not smaller than the beta value, filtering is not performed at step S1403. When the delta value is smaller than the beta value, it is determined to perform filtering and the filtering type to be applied to the relevant block boundary is determined. Alternatively, when the delta value is smaller than the beta value, it is determined not to perform filtering. When the delta value is not smaller than the beta value, it is determined to perform filtering. The filtering types in the embodiment shown in FIG. 14 include two types, strong filtering and weak filtering. At step S1406, it is determined which filtering among strong filtering and weak filtering is performed. Which filtering among strong filtering and weak filtering is performed may be determined by comparing a variation of pixel value inside the two blocks adjacent to the block boundary with a predetermined threshold value. Here, the variation of pixel value inside the block may be the variation used in calculating the delta value. Alternatively, the variation of pixel values inside each block adjacent to the block boundary may be compared with the predetermined threshold value. Alternatively, the variation of two or more pixel values adjacent to each other with the block boundary in the center may be compared with the predetermined threshold value. The predetermined threshold value may be at least one among a pre-defined constant value, a value signaled in a bitstream, and the beta value and the t_{c} value that are determined according to the characteristics, such the shape, the size, and the like, of the block. Alternatively, a value obtained by scaling the beta value and/or the t_{c} value may be used. Also, the variation of the pixel values may be scaled using the threshold value, and then the result may be compared with the threshold value. For example, which filtering among strong filtering and weak filtering is performed may be determined by whether the conditions in Equation 5 and/or Equation 6 below are satisfied.

Condition A: 2*dpq0<β/4

Condition B: abs(p3,0−p0,0)+abs(q3,0−(q0,0)<β/8

Condition C: abs(p0,0−q0,0)<(5*t_{c}+1)/2 [Equation 5]

Condition A: 2*dpq3<β/4

Condition B: abs(p3,3−p0,3)+abs(q3,3−q0,3)<β/8

Condition C: abs(p0,3−q0,3)<(5*t_{c}+1)/2 [Equation 6]

Equation 5 is an equation for the first column in FIG. 15, and Equation 6 is an equation for the fourth column in FIG. 15. When the conditions in Equation 5 and/or Equation 6 are satisfied, strong filtering is performed on the relevant block boundary at step S1407. Otherwise, weak filtering is performed at step S1408. Relating to calculation of the delta value as described above, all or some lines (rows or columns) that belong to a predetermined block adjacent to the block boundary may be used in determining the filtering type. The positions and/or the number of some lines may be pre-established and fixed in the device for encoding/the device for decoding, or may be variably determined depending on the size/shape of the block. Also, one or more pixels positioned on the line may be used. Here, multiple pixels may be continuously arranged or may be non-continuous pixels spaced apart from each other at predetermined intervals. When the shapes and/or sizes of the two blocks adjacent to the block boundary are different from each other, the indexes (for example, p0,0, p1,0, q2,0, and the like) used to specify the position of the pixel in the specification may vary adaptively.

When strong filtering is performed at step S1407, the two blocks adjacent to the block boundary are used and m (here, m is a constant of three or more) pixels per block are filtered. When weak filtering is performed at step S1408, the two blocks adjacent to the block boundary are used, or one block is used, and n (here, n is a constant smaller than m) pixels per block are filtered. The filtering application ranges shown below the steps S1407 and S1408 in FIG. 14 show an example in which m is three and n is two. m and n are not limited thereto. Also, the filtering method shown in FIG. 14 is not necessarily limited thereto. That is, each step may be skipped as needed, and it is possible to merge two or more steps into one step or to divide one step into two or more steps. Also, the execution order of some steps may be changed.

According to the present invention, when the basic block is divided using the quad tree structure and/or the binary tree structure, as described in FIGS. 3(b) and 7(a), the shape and size of the block to be the coding unit are variable and the block, and division takes place in such a manner as to include the coding unit in a rectangular shape.

According to the present invention, when dividing a block using the quad tree structure and/or the binary tree structure, a block that is no further divided is the coding unit that may be a unit of prediction, transform, and/or quantization. That is, the basic block may be divided into coding units in various sizes with the shape of a square or rectangle. Each coding unit may itself be the prediction unit and/or transform unit without being further divided for prediction or transform.

Since the coding unit is the transform unit immediately, the transform unit is various in size as the coding unit is various in size. Accordingly, blocking artifacts that occur at the boundary of the transform unit may be more various depending on the shape, size, and/or characteristics of the block. Therefore, the strength and/or application range of in-loop filtering are required to be adjusted according to the shape, size, and/or characteristics of the block adjacent to the block boundary.

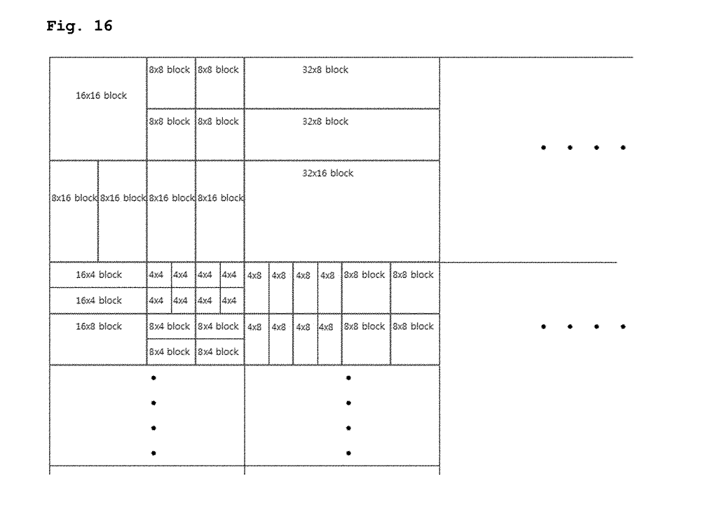

FIG. 16 is a diagram illustrating a structure of a block divided using a quad tree structure and/or a binary tree structure according to the present invention and block boundaries to which in-loop filtering is applied according thereto. In FIG. 16, the block boundary shown in the thick line is an example of the block boundary to which in-loop filtering may be applied.

Considering complexity of the device for encoding and the device for decoding, filtering may not be performed on the block boundary of the block (ex. 4×8, 8×4, 4×4, and the like) of which the width or height is four. That is, in FIG. 16, filtering may not be performed on the block boundary designated by the block link.

FIG. 17 is a flowchart illustrating filtering according to another embodiment of the present invention. Referring to FIG. 17, as described in FIG. 16, a modified in-loop filtering method with respect to the image including a non-uniform block will be described. Here, the non-uniform block means a block of which the width is different from the height.

In describing each step in FIG. 17, the repeated description common to the description of each step in FIG. 14 will be omitted. Hereinafter, differences between the method in FIG. 17 and the method in FIG. 14 will be mainly described. At step S1401 in FIG. 14, the BS value is calculated on the basis of the PU and the TU, but at step S1701 in FIG. 17, the BS value is calculated on the basis of two coding units (CUs) adjacent to the block boundary.

The BS value may have, as described above, the first value and/or the second value or more. At step S1702, depending on whether the BS value is zero or not, filtering may not be performed at step S1703, or filtering may be performed at step S1704.

At step S1704, a delta value, a beta value, and t_{c} value may be calculated/derived. At step S1705, the delta value may be compared with the beta value. At step S1705, when determining that the delta value is smaller than the beta value, whether at least one block among the blocks adjacent to the block boundary is a non-uniform block or not is checked at step S1706. When two blocks adjacent to the block boundary are both square blocks, filtering according to steps S1406 to S1408 in FIG. 14 may be performed at step S1707. When at least one block among the two blocks adjacent to the block boundary is a non-uniform block, according to another embodiment of the present invention, operations at step S1708 and the subsequent steps are performed.

Alternatively, even when the shapes and/or sizes of the two blocks adjacent to the block boundary are different from each other, according to another embodiment of the present invention, operations at step S1708 and the subsequent steps are performed. At step S1708, the filtering type may be selected according to a predetermined criterion. The filtering types may include, for example, strong filtering and weak filtering, without being limited thereto as described above. When strong filtering is selected, strong filtering is performed at step S1709, and when weak filtering is selected, weak filtering is performed at step S1710. As shown below the steps S1709 and S1710, the ranges to which filtering is applied with respect to the two blocks adjacent to the block boundary may be different from each other. The specific filtering application range will be described later. The filtering method shown in FIG. 17 is not necessarily limited thereto. That is, each step may be skipped as needed, and it is possible to merge two or more steps into one step or to divide one step into two or more steps. Also, the execution order of some steps may be changed. Also, in the range not inconsistent with the embodiment described with reference to FIG. 17, the same description referring to FIG. 14 is applied.

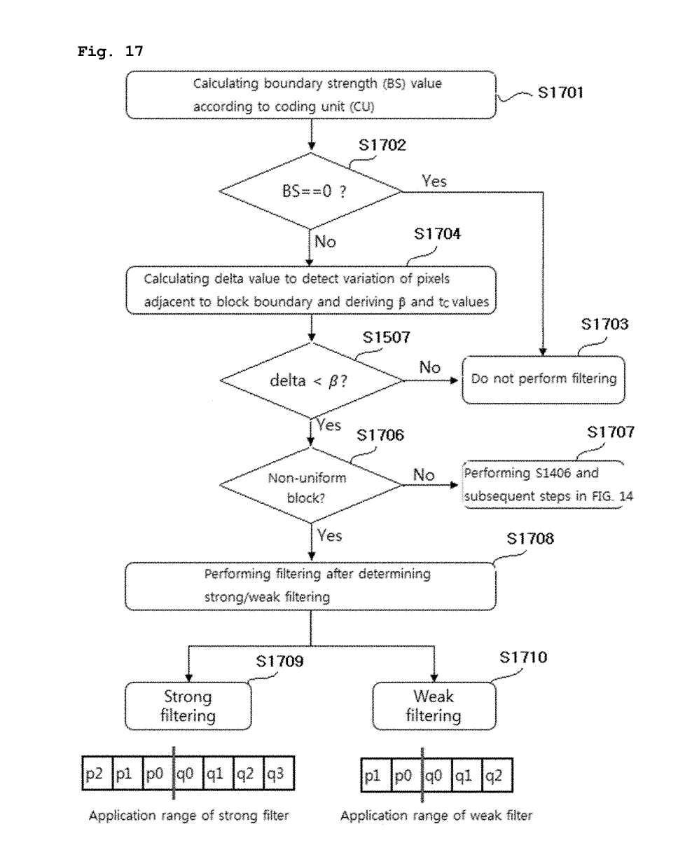

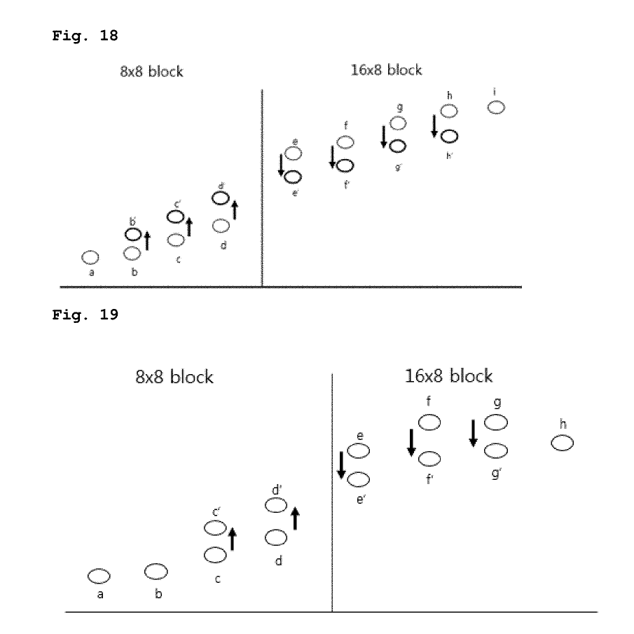

FIG. 18 is a diagram illustrating pixels to which strong filtering is applied according to step S1709 in FIG. 17. As described in FIG. 18, the two blocks adjacent to the block boundary (designated by the red line) may be 8×8 and 16×8, respectively. A block in a 16×8 size is a non-uniform block. As described above with reference to FIG. 14, whether to apply strong filtering or weak filtering to the block boundary may be determined on the basis of quantization parameters of two blocks or at least one block among the two blocks. When at least one block among the two blocks adjacent to the block boundary is a non-uniform block, the widths and/or heights of the two blocks adjacent to the block boundary are also considered. Specifically, considering widths and heights of the two blocks P and Q adjacent to the block boundary, more pixels near the block boundary are filtered with respect to the larger block in size. This is because blocking artifacts that occur due to transform and quantization are related to the quantization parameter as well as to the sizes of the two blocks adjacent to the block boundary. For example, regarding the relatively large block among the two blocks adjacent to the block boundary, AC components of the block other than DC components may be quantized due to a quantization step (Qstep) size and may be removed. Here, the positions where the AC parts are removed inside the relatively large block may be adjacent to the DC parts of the nearby block. In this case, blocking artifacts may occur. In order to reduce this mismatch, in the filtering method according to another embodiment of the present invention, filtering may be performed considering the shape, size, and/or characteristics of the block.

The process of deriving the strength (BS) of the block boundary, of determining whether to perform filtering, of selecting strong filtering and weak filtering, and so on may be performed on the basis of the sizes of the two blocks adjacent to the block boundary, or may be performed by the method described with reference to FIG. 14.

As described in FIG. 18, when two blocks adjacent to the block boundary are respectively 8×8 and 16×8 in size and strong filtering is performed on the relevant block boundary, more pixels are filtered with respect to the larger block in size. For example, with respect to the 8×8 block, three pixels (b, c, and d) are filtered, and with respect to the 16×8 block which is relatively large, four pixels (e, f, g, and h) are filtered. The number of pixels to be filtered is not limited thereto. More pixels may be filtered with respect to the respectively large block in size than the respectively small block in size. Filtering on filtering target pixels shown in FIG. 18 may be performed by using an average and/or a weighted average of pixel values inside the two blocks adjacent to the block boundary, or by calculating a median value corresponding thereto. For example, filtering may be performed using Equation 7 below.

b′=(2a+2b+c+d+e+f)/8

c′⁼(b+c+d+e+f)/5

d′=(b+3c+5d+3e+f+8)/16

e′=(c+3d+5e+3f+g+8)/16

f′=(c+d+e+f+g)/5

g′=(c+d+e+f+g+2g+2h)/8

h′=(2d+2e+f+g+h+i+4)/8 [Equation 7]

In Equation 7, the letters a, b, c, d, e, f, g, h, and i represent reconstructed pixel value obtained by adding the prediction signal and the decoded residual signal, and the letters expressed as b′, c′, d′, e′, f′, g′, and h′ represent modified pixel values after performing filtering through filter coefficients.

FIG. 19 is a diagram illustrating pixels to which weak filtering is applied according to step S1710 in FIG. 17. As described in FIG. 19, when the two blocks adjacent to the block boundary are 8×8 and 16×8 in size, respectively, and weak filtering is performed on the relevant block boundary, for example, with respect to the 8×8 block, two pixels (c and d) are filtered, and with respect to the 16×8 block which is relatively large, three pixels (e, f, and g) are filtered.

The filtering process may be performed by calculating a Δ value on the basis of the difference value between pixel values inside the two blocks adjacent to the block boundary. Here, the Δ value may be calculated by applying a larger weighting factor to the difference value between the two pixel values adjacent to the block boundary. Here, the difference value between the two pixel values adjacent to the block boundary may be in proportion to the A value. Further, the Δ value may be calculated using the difference value between the pixel values that are not directly adjacent to the block boundary. Here, the difference value between the pixel values that are not directly adjacent to the block boundary may be in inverse proportion to the Δ value. The Δ value may be calculated one or more of difference values of the pixel values, and the calculated value may be scaled using a pre-defined constant, a value determined according to the characteristics, such as the shape, the size, and the like, of the block, and/or a value signaled in a bitstream. For example, the Δ value may be calculated at Equation 8 below. The calculated Δ value may be added to or subtracted from the value of the pixel which is a filtering target, thereby calculating the filtered pixel value.

Δ=(9*(q0−p0)−3*(q1−p1)+8)>>4 [Equation 8]

Weak filtering may be performed on only one block or two blocks. When weak filtering is applied to the block boundary, in which at least one block among the two blocks adjacent to the block boundary is a non-uniform block, the pixels d and e of the block boundary are filtered by adding or subtracting the difference value A calculated by Equation 8 to or from the respective pixel values. In the case of the pixels (f and g) positioned inside the non-uniform block, filtering may be performed by using an average and/or a weighted average of pixel values inside the two blocks that are adjacent to the block boundary, or by calculating a median value corresponding thereto. For example, as Equation 9 below, filtering may be performed using nearby pixel values of the block boundary.

f′=(e+5f+2g)>>3

g′=(2f+4g+2h)>>3 [Equation 9]

In FIG. 19, when the left of the block boundary is a 16×8 block, with respect to the two pixels b and c, Equation 9 is applied similarly.

Filtering according to another embodiment of the present invention may be performed when at least one block among the two blocks positioned on the block boundary is a non-uniform block. Also, filtering according to another embodiment of the present invention may be applied to a case where the two blocks positioned on the block boundary are different in size. When the two blocks adjacent to the block boundary are the same in size or are in the square shape, filtering described with reference to FIG. 14 is performed.

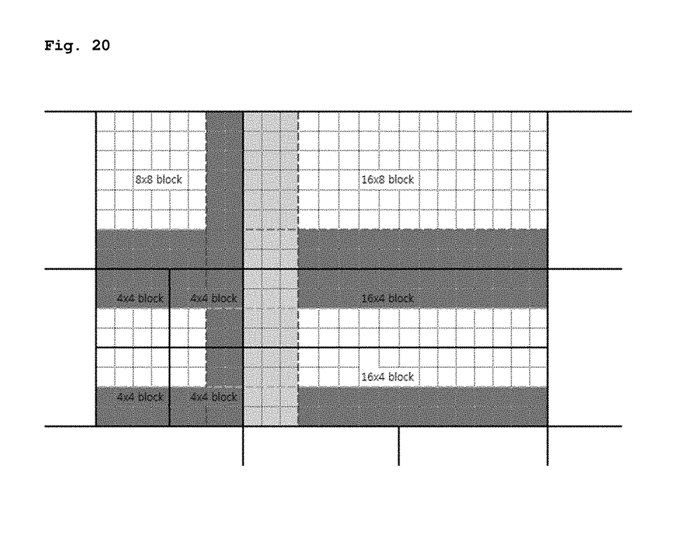

FIG. 20 is a diagram illustrating an example of a range of pixels to which filtering is applied when performing weak filtering according to the present invention. In FIG. 20, the thick lines denote the block boundaries of the blocks. Each square of the grid inside the thick lines means a pixel inside each block. In FIG. 20, for example, the minimum size of the block on which filtering is performed is 8×8. Therefore, filtering may not be performed on the boundary of the block in which the horizontal and/or vertical size is four. In FIG. 20, the portion colored in dark gray represents the pixel range to which filtering described with reference to FIG. 14 is applied. In FIG. 20, the portion colored in bright gray, which is an area inside the non-uniform block (16×8), represents the pixel range to which filtering described with reference to FIG. 17 is applied.

According to the present invention, the filter module 150 of the device for encoding the image and the filter module 240 of the device for decoding the image may further include a corner outlier filter that filters a corner outlier which is a filtering target according to the present invention. The corner outlier filter may be provided before or after the deblocking filter, before or after the offset correction module, or before or after the adaptive loop filter (ALF). Alternatively, filtering according to the present invention may be performed as a part of in-loop filtering and may also be performed on pixels used as a reference of intra prediction or inter prediction.

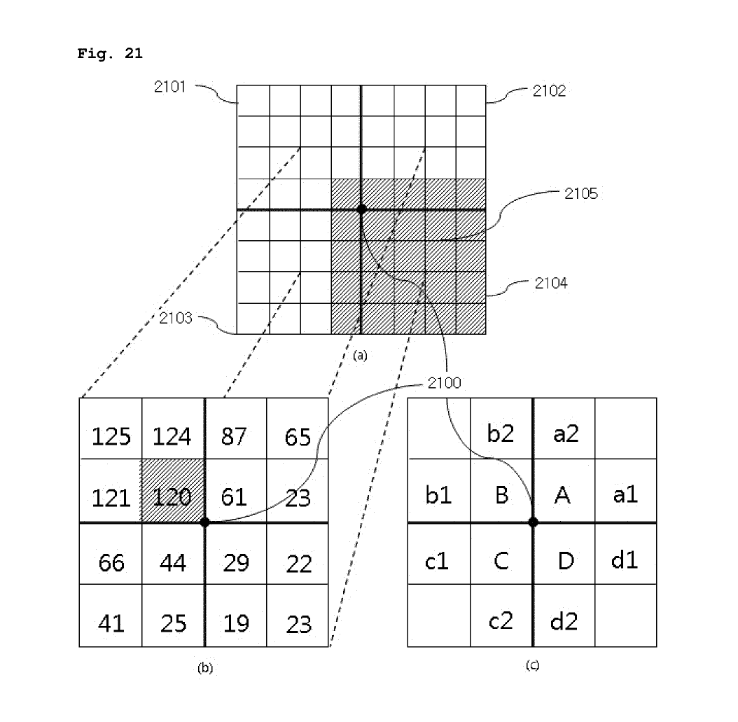

FIG. 21(a) is a diagram illustrating a corner outlier that is a filtering target of a corner outlier filter according to an embodiment of the present invention. FIG. 21(b) is a diagram illustrating examples of pixel values of pixels in a 2×2 area with an intersection point of FIG. 21(a) in the center. FIG. 21(c) is a diagram illustrating indexes for indicating positions of pixels that are used to detect and filter a corner outlier. In FIGS. 21(a), 21(b), and 21(c), the parts indicated by thick lines mean the boundaries between blocks, and each square of grid corresponds to one pixel.

As described in FIG. 21(a), in the image decoded on a per-block basis, the corners of four blocks 2101, 2102, 2103, and 2104 meet with one intersection point 2100 in the center. The sizes of the four blocks 2101, 2102, 2103, and 2104 may be different from each other, or some or all of the sizes may be the same. The four blocks 2101, 2102, 2103, and 2104 may be unit blocks of prediction, quantization, or transform. The quantization parameters used in quantization (or inverse quantization) of the four blocks 2101, 2102, 2103, and 2104 may be different from each other, or some or all of the quantization parameters may be the same.

The decoding image may include various types of image area, and the boundary (edge) of the image area may not coincide with the boundary of the block which is a unit of encoding/decoding. For example, in FIG. 21(a), an image area 2105 in the hatched portion may be preset over multiple blocks 2101, 2102, 2103, and 2104, and may be present over only a corner portion with respect to the block 2101. Here, the four corner pixels adjacent to each other with the intersection point 2100 in the center are adjacent pixels that belong to the same image area 2105, so that it is predicted to have similar pixel values.

However, because encoding/decoding processing, such as prediction, quantization, transform, and the like, is performed on a per-block basis, pixel values may be significantly different between the four adjacent corner pixels that belong to the same image area 2105 included in the decoded image. For example, in FIG. 21(a), among the four adjacent corner pixels with the intersection point 2100 in the center, the pixel value of the corner pixel that belongs to the block 2101 on the upper left side may be extremely smaller or larger than the pixel values of the other three corner pixels.

In the present invention, when the four blocks 2101, 2102, 2103, and 2104 included in the decoded image meet with one intersection point 2100 in the center, the corner outlier filter detects, among the four adjacent corner pixels with the intersection point 2100 in the center, the corner pixel having a pixel value that is greatly different from pixel values of the other corner pixels, as the corner outlier for filtering. That is, due to quantization error, prediction error, or the like, when the corner pixel value of one block within the reconstructed image is greatly different from corner pixel values of other blocks adjacent thereto, the corner outlier may be defined as the corner pixel including the noise. Also, the corner outlier according to the present invention may include a pixel of which a pixel value is greatly different from pixel values of nearby adjacent pixels, and the nearby pixels.

FIG. 21(b) is an enlarged diagram of a 2×2 area with the intersection point 2100 in FIG. 21(a) in the center. In FIG. 21(b), the number included in each square of the grid represents the pixel value of the pixel included in the block, illustratively.

As described in FIG. 21(b), the four corner pixels adjacent to the intersection point 2100 may have values of 120, 61, 44, and 29 as pixel values, respectively. As described above, it is found that among the four adjacent corner pixels, the pixel value, which is 120, of the corner pixel (the hatched portion) is greatly different from pixel values (61, 44, and 29) of the other three corner pixels. Therefore, the corner pixel of which the pixel value is 120 may correspond to the corner outlier that is a filtering target of the present invention.

FIG. 21(c) is a diagram illustrating indexes for indicating positions of pixels in the 2×2 area that are used to detect and filter a corner outlier. As described in FIG. 21(c), the positions of the adjacent corner pixels with the intersection point 2100 in the center are designated by large letters (A, B, C, and D), respectively, and the positions of the pixels adjacent to the respective corner pixels are designated by mixing small letters and numbers (a1, a2, b1, b2, c1, c2, d1, d2). The input of the corner outlier filter that is used to detect and filter the corner outlier is not limited to the pixels in the area shown in FIG. 21(c). With the boundary between blocks in the center, pixels within areas that are vertically, horizontally, and/or diagonally adjacent to each other may be used. For example, pixels of the square area such as 3×3, 4×4, and the like may be used, and alternatively, pixels of the rectangular area such as 1×2, 2×1, 1×3, 3×1, 1×4, 4×1, 2×3, 3×2, 2×4, 4×2, 3×4, 4×3, and the like may be used. The pixels used as the input of the corner outlier filter may be pixels at the positions that the device for encoding/the device for decoding already knows. Alternatively, information related to the positions of the pixels may be included in the bitstream for signaling.

Hereinafter, with reference to the indexes related to the positions of the pixels shown in FIG. 21(c), the operation of the corner outlier filter will be described. Further, the description is given assuming that among the indexes related to the positions of the pixels shown in FIG. 21(c), the pixel value of the corner pixel B is greatly different from the pixel values of the other adjacent corner pixels A, C, and D.

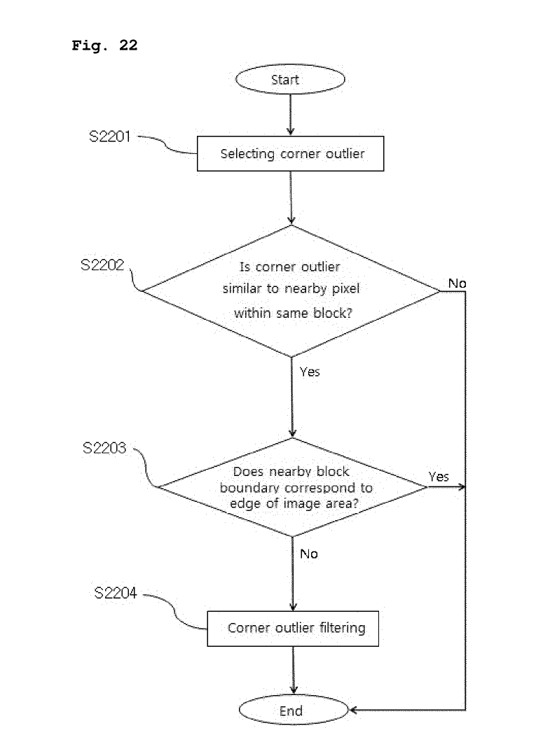

FIG. 22 is a flowchart illustrating operation of a corner outlier filter according to an embodiment of the present invention.

As the input of the corner outlier filter, with one intersection point 2100 in the center, the pixel values of the pixels included in the four adjacent blocks 2101, 2102, 2103, and 2104 may be used. For example, the pixel values of the pixels within the 2×2 area shown in FIG. 21(c) may be used as the input of the corner outlier filter.

At a corner outlier selection step S2201, when four blocks 2101, 2102, 2103, and 2104 are adjacent to each other with one intersection point 2100 in the center, among the four corner pixels (A, B, C, and D) adjacent to the intersection point, the corner pixel of which the pixel value is greatly different from the pixel values of the other adjacent corner pixels is selected as the corner outlier.

The selection of the corner outlier may be performed using a difference value between pixel values of corner pixels adjacent to the intersection point and a first threshold value. The difference value between the pixel values may be a difference value between pixel values of pixels adjacent to each other horizontally, vertically, and/or diagonally. The first threshold value may be set on the basis of quantization parameters. For example, the first threshold value may be one of quantization parameters of the four adjacent blocks 2101, 2102, 2103, and 2104, or may be, among the quantization parameters of the four adjacent blocks 2101, 2102, 2103, and 2104, a maximum value, a minimum value, a mode, median value, an average value, a weighted average value, and/or a value derived by scaling these values with a predetermined constant value. The predetermined constant value may be a fixed value or may be variable, or may be obtained on the basis of information signaled as being included in the bitstream. However, the first threshold value is not limited thereto. A pre-defined value may be used, or the first threshold value may be set to another value according to the characteristics of the image, and the like. Alternatively, a value signaled by the bitstream may be used.

According to the embodiment of the present invention, from Equation 10 below, among the four corner pixels (A, B, C, and D) adjacent to the intersection point, the corner pixel of which the pixel value is greatly different from the pixel values of the other adjacent corner pixels may be selected as the corner outlier.

[Equation 10]

```
if (| A − C |>| B − D |)
  if (| A − B |>| C − D |)
    if (| A − B |> threshold & & | A − C |> threshold & &
    | A − D |> threshold)
      returan A
  else
    if (| C − A |> threshold & & | C − B |> threshold & &
    | C − D |> threshold)
      return C
else
  if (| B − C |>| A − D )
    if (| B − A |> threshold & & | B − C |> threshold & &
    |B − D |> threshold)
      return B
  else
    if (| D − A |> threshold & & | D − B |> threshold & &
    |C − D |> threshold)
      return D
```

According to Equation 10, first, on the basis of the difference values between pixel values of the four corner pixels, among the four corner pixels, the corner pixel of which the pixel value is greatly different from the pixel values of the other adjacent corner pixels may be selected.

Specifically, by comparing the difference value between pixel values of the corner pixel A and the corner pixel C with the difference value between pixel values of the corner pixel B and the corner pixel D, it is possible to determine whether the corner outlier is included in the corner pixel A or the corner pixel C, or the corner outlier is included in the corner pixel B or the corner pixel D. For example, when the difference value between pixel values of the corner pixel A and the corner pixel C is smaller than the difference value between pixel values of the corner pixel B and the corner pixel D, it is determined that the corner outlier is included in the corner pixel B or the corner pixel D.

When determining that the corner outlier is included in the corner pixel B or the corner pixel D, the difference value between pixel values of the corner pixel B and the corner pixel C is compared with the difference value between pixel values of the corner pixel A and the corner pixel D. When the difference value between pixel values of the corner pixel B and the corner pixel C is larger than the difference value between pixel values of the corner pixel A and the corner pixel D, it is determined that the corner outlier is included in the corner pixel B or the corner pixel C.

In the above example, through the first comparison process (if(|A−C|>|B−D|)), when it is determined that the corner outlier is included in the corner pixel B or the corner pixel D, and through the second comparison process (if(|B−C|>|A−D|)), when it is determined that the corner outlier is included in the corner pixel B or the corner pixel C, through the two comparison processes, it is found that the pixel value of the corner pixel B is greatly different from the pixel values of the other corner pixels A, C, and D. Therefore, it is determined that the corner pixel B is the corner outlier.

As described above, through the process of comparing the differences between pixel values of adjacent corner pixels, among the four adjacent corner pixels (A, B, C, and D), the corner pixel of which the pixel value is greatly different from the pixel values of the other three adjacent corner pixels may be selected. However, among the four adjacent corner pixels, the selection of the corner pixel of which the pixel value is greatly different from the pixel values of the other corner pixels may be performed by various methods other than the method according to Equation 10.

In Equation 10, through the two comparison processes, among the four adjacent corner pixels (A, B, C, and D), as the corner pixel of which the pixel value is greatly different from the pixel values of the other three adjacent corner pixels, when the corner pixel B is selected, the difference values between the pixel value of the selected corner pixel B and each of the pixel values of the other three adjacent corner pixels A, C, and D may be compared with a first threshold value. The first threshold value may be set to, for example, QP/3 for use that is ⅓ of the average value of the quantization parameters of the four adjacent blocks. However, the first threshold value is not limited thereto, may be set to another value according to the characteristics of the image, and the like. Alternatively, a value signaled by the bitstream may be used.

In Equation 10, when the difference values between the pixel value of the selected corner pixel B and each of the pixel values of the other three adjacent corner pixels A, C, and D are all larger than the first threshold value, the selected corner pixel B is selected as the corner outlier. In Equation 10, when the difference value between the pixel value of the selected corner pixel B and the pixel value of at least one corner pixel of the other three adjacent corner pixels A, C, and D is smaller than the first threshold value, the corner outlier is not selected. In this case, the corner outlier filtering operation on the input of the corner outlier filter may be terminated.

At step S2201, when the corner outlier is selected, the similarity between the corner outlier and the pixel adjacent to the selected corner outlier, which belongs to the same block as the selected corner outlier, is determined at step S2202. Step S2202 may not be performed depending on the situation, and for example, whether to omit the step S2202 may be determined on the basis of the characteristics of the image or on the signaled information.

For example, according to Equation 10, when the corner pixel B in FIG. 21(c) is selected as the corner outlier, the similarity between the corner pixel B and the horizontally nearby pixel b1 and/or the vertically nearby pixel b2, which belongs to the same block 2101 as the corner pixel B, is determined.

The determination of the similarity may be performed on the basis of the difference value between pixel values of the pixel and the corner pixel B within the same block. Here, the pixel within the same block may be positioned on the same horizontal line and/or vertical line as the corner pixel B. The pixel within the same block may be one or more pixels continuously adjacent to the corner pixel B, or may be one or more pixels at positions spaced apart therefrom by a predetermined distance. For example, the difference value between the pixel values of the corner pixel B and the horizontally and/or vertically nearby pixels (b1 and b2) within the same block may be compared with a second threshold value. The second threshold value may be set on the basis of the quantization parameter. For example, the second threshold value may be one of quantization parameters of the four adjacent blocks 2101, 2102, 2103, and 2104, or may be, among the quantization parameters of the four adjacent blocks 2101, 2102, 2103, and 2104, a maximum value, a minimum value, a mode, median value, an average value, a weighted average value, and/or a value derived by scaling these values with a predetermined constant value. The predetermined constant value may be a fixed value or may be variable, or may be obtained on the basis of information signaled as being included in the bitstream. According to the embodiment of the present invention, the second threshold value may be set to, for example, QP/6 for use that is ⅙ of the average value of the quantization parameters of the four adjacent blocks. However, the second threshold value is not limited thereto, may be set to another value according to the characteristics of the image, and the like. Alternatively, a value signaled by the bitstream may be used.

According to the embodiment of the present invention, using Equation 11 below, the similarity between the corner pixel B and the nearby pixels (b1 and b2) within the same block may be determined.

$$if ( ( \vert B - b 1 \vert < \frac{QP}{6} ) \&\& ( \vert B - b 2 \vert < \frac{QP}{6} ) \qquad [ Equation 11 ]$$

In Equation 11, the difference value between pixel values of the corner pixel B and the horizontally nearby pixel b1 is compared with the second threshold value, which is QP/6. When the difference value between pixel values of the corner pixel B and the pixel b1 is smaller than QP/6, it is determined that the corner pixel B and the pixel b1 are similar to each other. The determination of the similarity between the corner pixel B and the pixel b2 may be performed in the same manner.

As the result of determining the similarity, when it is determined that the corner pixel B is not similar to the nearby pixels (b1 and b2) within the same block, the corner outlier filtering operation on the corner pixel B, which is selected as the corner outlier, is terminated.

As the result of determining the similarity, when it is determined that the corner pixel B is similar to the nearby pixels (b1 and b2) within the same block, proceeding to step S2203 takes place and processing for the selected corner outlier is continued.

At step S2203, it is determined whether a horizontal block boundary and a vertical block boundary adjacent to the corner outlier are edges of the image area included in the image. Step S2203 may not be performed depending on the situation, and for example, whether to omit the step S2203 may be determined on the basis of the characteristics of the image or on the signaled information.

Step S2203 is for determining whether the corner pixel B selected as the corner outlier is included in a different image area from the other adjacent corner pixels (A, C, and D) and it is inappropriate to perform filtering. For example, when the image area to which the corner pixel B belongs is different from the image area to which the corner pixels A, C, and D belong, the pixel value of the corner pixel B is greatly different from the pixel values of the other adjacent corner pixels A, C, and D. In this case, the difference in pixel values is not regarded as noise due to, for example, quantization on a per-block basis, and the like. Therefore, in this case, it is desirable not to perform corner outlier filtering on the corner pixel B.

At step S2203, it is determined whether the horizontal block boundary and the vertical block boundary adjacent to the corner pixel B which is the corner outlier are edges of the image area. When it is determined that the horizontal block boundary and the vertical block boundary adjacent to the corner pixel B are the edges of the image area, it is determined that the corner pixel B and the other adjacent corner pixels A, C, and D belong to different image areas.

According to the embodiment of the present invention, the edge determination may be performed using a third threshold value and at least one pixel adjacent to the horizontal block boundary and the vertical block boundary, as pixels included in the blocks 2102, 2103, and 2104 adjacent to the corner pixel B which is the corner outlier. The third threshold value may be set on the basis of the quantization parameter. For example, the third threshold value may be one of quantization parameters of the four adjacent blocks 2101, 2102, 2103, and 2104, or may be, among the quantization parameters of the four adjacent blocks 2101, 2102, 2103, and 2104, a maximum value, a minimum value, a mode, median value, an average value, a weighted average value, and/or a value derived by scaling these values with a predetermined constant value. The predetermined constant value may be a fixed value or may be variable, or may be obtained on the basis of information signaled as being included in the bitstream. However, the third threshold value is not limited thereto, may be set to another value according to the characteristics of the image, and the like. Alternatively, a value signaled by the bitstream may be used. According to the embodiment of the present invention, the third threshold value may be set to, for example, QP/6 for use that is ⅙ of the average value of the quantization parameters of the four adjacent blocks. However, the third threshold value is not limited thereto, may be set to another value according to the characteristics of the image, and the like. Alternatively, a value signaled by the bitstream may be used.

According to the embodiment of the present invention, in the edge determination, as the pixels included in the blocks adjacent to the corner outlier, a variation of the pixels adjacent to the horizontal block boundary and the vertical block boundary may be compared with the third threshold value. For example, when the corner pixel B is selected as the corner outlier, using Equation 12 below, it is determined whether the horizontal block boundary the vertical block boundary adjacent to the corner pixel B are edges of the image area.

$$if ( \vert \frac{c 1 + C + D + d 1}{4} - c 1 \vert < \frac{QP}{6} \&\& \vert \frac{c 1 + C + D + d 1}{4} - d 1 \vert < \frac{QP}{6} ) \\ if ( \vert \frac{a 2 + A + D + d 2}{4} - a 2 \vert < \frac{QP}{6} \&\& \vert \frac{a 2 + A + D + d 2}{4} - d 2 \vert < \frac{QP}{6} ) \\ else \begin{matrix}:: Determine as Edge \\ :: Move to Next Step\end{matrix} \qquad [ Equation 12 ]$$

In Equation 12, in order to determine whether the horizontal block boundary adjacent to the corner pixel B which is the corner outlier is the edge, as the pixels included in the block adjacent to the corner pixel B, the pixels c1, C, D, and d1 adjacent to the horizontal block boundary may be used. As the variation of the pixels (c1, C, D, and d1), for example, a difference value between the pixel value of the pixel c1 and an average value of pixel values of the pixels (c1, C, D, and d1) and/or a difference value between the pixel value of the pixel d1 and an average value of pixel values of the pixels (c1, C, D, and d1) may be used. Alternatively, it is possible to use a process of comparing a predetermined reference value with a difference value between two or more pixel values among pixels adjacent to the horizontal block boundary. The predetermined reference value may be determined on the basis of the characteristics of the image, or may be signaled. When the variation of the pixels (c1, C, D, and d1) is smaller than the third threshold value which is QP/6, it is determined that the variation of the pixels (c1, C, D, and d1) is small and the horizontal block boundary adjacent to the pixels (c1, C, D, and d1) is the edge of the image area.

Similarly, in order to determine whether the vertical block boundary adjacent to the corner pixel B which is the corner outlier is the edge, as the pixels included in the block adjacent to the corner pixel B, the pixels a2, A, D, and d2 adjacent to the vertical block boundary may be used. As the variation of the pixels (a2, A, D, and d2), for example, a difference value between the pixel value of the pixel a2 and an average value of pixel values of the pixels (a2, A, D, and d2) and/or a difference value between the pixel value of the pixel d2 and an average value of pixel values of the pixels (a2, A, D, and d2) may be used. Alternatively, it is possible to use a process of comparing a predetermined reference value with a difference value between two or more pixel values among pixels adjacent to the vertical block boundary. The predetermined reference value may be determined on the basis of the characteristics of the image, or may be signaled. When the variation of the pixels (a2, A, D, and d2) is smaller than the third threshold value which is QP/6, it is determined that the variation of the pixels (a2, A, D, and d2) is small and the vertical block boundary adjacent to the pixels (a2, A, D, and d2) is the edge of the image area.

In the embodiment of the present invention, Equation 12 is used to determine whether the block boundary is the edge of the image area. However, the method of determining whether to be the edge of the image area is not limited thereto, and various methods may be applied.

At step S2203, as the result of determination according to Equation 12, when it is determined that the horizontal block boundary or the vertical block boundary adjacent to the corner pixel B which is the corner outlier is not the edge of the image area, corner outlier filtering at step S2204 is performed.

At step S2203, as the result of determination according to Equation 12, when it is determined that the horizontal block boundary and the vertical block boundary adjacent to the corner pixel B which is the corner outlier are the edges of the image area, the corner outlier filtering operation on the corner pixel B is terminated or edge determination using Equation 13 below is further performed. Additional edge determination using Equation 13 below may not be performed depending on the situation, and for example, whether to omit the additional edge determination using Equation 13 below may be determined on the basis of the characteristics of the image or on the signaled information.

$$if ( ( \vert B - A \vert < \frac{QP}{2} ) \&\& ( \vert B - C \vert < \frac{QP}{2} ) ) \qquad [ Equation 13 ]$$

In Equation 13, it is determined whether a difference between pixel values of the corner pixel B which is the corner outlier and the nearby corner pixel A is smaller than a fourth threshold value. The fourth threshold value may be set on the basis of the quantization parameter. For example, the fourth threshold value may be one of quantization parameters of the four adjacent blocks 2101, 2102, 2103, and 2104, or may be, among the quantization parameters of the four adjacent blocks 2101, 2102, 2103, and 2104, a maximum value, a minimum value, a mode, median value, an average value, a weighted average value, and/or a value derived by scaling these values with a predetermined constant value. The predetermined constant value may be a fixed value or may be variable, or may be obtained on the basis of information signaled as being included in the bitstream. However, the fourth threshold value is not limited thereto, may be set to another value according to the characteristics of the image, and the like. Alternatively, a value signaled by the bitstream may be used. According to the embodiment of the present invention, the fourth threshold value may be set to, for example, QP/2 for use that is ½ of the average value of the quantization parameters of the four adjacent blocks. However, the fourth threshold value is not limited thereto, may be set to another value according to the characteristics of the image, and the like. Alternatively, a value signaled by the bitstream may be used. The first to fourth threshold values used in the embodiment of the present invention may be all the same or different, or some of the threshold values may be the same or different.

In Equation 13, it is determined whether a difference between pixel values of the corner pixel B which is the corner outlier and the nearby corner pixel A is smaller than QP/2. When the difference between pixel values of the corner pixel B and the nearby corner pixel A is smaller than QP/2, it is finally determined that the vertical block boundary adjacent to the corner pixel B is the edge of the image area.

Similarly, in Equation 13, it is determined whether a difference between pixel values of the corner pixel B which is the corner outlier and the nearby corner pixel C is smaller than QP/2. When the difference between pixel values of the corner pixel B and the nearby corner pixel C is smaller than QP/2, it is finally determined that the horizontal block boundary adjacent to the corner pixel B is the edge of the image area.

At step S2203, as the result of edge determination according to Equation 12 and/or Equation 13, when it is determined that both the horizontal block boundary and the vertical block boundary adjacent to the corner pixel B are the edges of the image area, the process is terminated without performing filtering at step S2204.

At step S2203, as the result of edge determination according to Equation 12 and/or Equation 13, when it is determined that the horizontal block boundary or the vertical block boundary adjacent to the corner pixel B is not the edge of the image area, proceeding to step S2204 takes place and corner outlier filtering on the corner pixel B is performed. As described above, through steps S2201 to S2203 in order, the corner outlier which is the filtering target may be determined. However, steps S2201 to S2203 do not limit the determination order, and the determination order may be adaptively changed without departing from the essence of the present invention. Also, the corner outlier which is the filtering target may be determined by selectively using at least one among steps S2201 to S2203.

Filtering on the corner outlier and the nearby pixels may be performed in a direction in which the difference from the nearby pixels is reduced, and for example, may be performed in a direction in which the difference from the pixel values of the nearby corner pixels belonging to another block is reduced. According to the embodiment of the present invention, for example, filtering may be performed using Equation 14 below.

B′=((4×B)+A+C+(2×D)+4)<<3

b1′=(B′+(3×b1)+2)<<2

b2′=(B′+(3×b2)+2)<<2 [Equation 14]

In Equation 14, A, B, C, D, b1, and b2 denote the pixel values of the pixels at the position shown in FIG. 21(c), respectively. B′, b1′, and b2′ denote values obtained by filtering the pixel values at the positions of B, b1, b2 shown in FIG. 21(c), respectively. The filtered pixels include the corner outlier and the pixels horizontally, vertically, and/or diagonally adjacent thereto. As a filtering coefficient used in filtering, a predetermined value by the device for encoding/the device for decoding may be used. Alternatively, the filtering coefficient may be derived on the basis of the characteristics of the image, or information on the filtering coefficient may be signaled. Filtering is not necessarily performed only the boundaries of the prediction, quantization, and/or transform blocks. For example, filtering may be only performed on the boundary of a block in a predetermined size, such as the boundaries of the 8×8, 16×16, 32×32, and 64×64 blocks. As information on the type and/or size of the block on which filtering is performed, information already known by the device for encoding/the device for decoding may be used. Alternatively, it may be determined on the basis of the characteristics of the image, or information thereon may be signaled.

The method according to the embodiment of the present invention consists of one or more steps, and is described in a predetermined order. However, the present invention is not limited to the predetermined order. For example, the execution order of steps may be changed. Alternatively, one or more steps may be simultaneously performed. Alternatively, one or more steps may be added to an arbitrary position.

The embodiments according to the invention as described above may be implemented in the form of program instructions that can be executed by various computer components, and may be stored on a computer-readable recording medium. The computer-readable recording medium may include program instructions, data files, data structures and the like, separately or in combination. The embodiments of the present invention may be implemented by a hardware device having one or more processors. One or more processors may be configured in such a manner as to operate as software modules, individually.

The present invention is intended to cover not only the above-described embodiments, but also various alternatives, modifications, equivalents and other embodiments that may be included within the spirit and scope of the present invention as defined by the appended claims.

### INDUSTRIAL APPLICABILITY

The present invention may be used in encoding/decoding an image.

1. A video signal processing method of dividing an input image on a per-block basis for encoding, the method comprising:
determining, at a division determination step, whether to divide a current block;
dividing, at a block division step, the current block into multiple sub blocks on the basis of the determination;
generating block division information on division of the current block; and
encoding, at an encoding step, the block division information, the current block, or the sub blocks.

2. The method of claim 1, wherein at the block division step, the current block is divided using two or more tree structures.

3. The method of claim 2, wherein at the block division step, the block is divided using at least one among the two or more tree structures as a main division structure and the others as sub division structures.

4. The method of claim 3, wherein the block division information includes main division information for indicating whether the block is divided using the main division structure, and
when the main division information indicates that the block is divided using the main division structure and there are multiple main division structures, the block division information further includes information for specifying one among the multiple main division structures.

5. The method of claim 3, wherein the block division information includes main division information for indicating whether the block is divided using the main division structure, and
when the main division information indicates that the block is not divided using the main division structure, the block division information further includes sub division information for indicating whether the block is divided using the sub division structure.

6. The method of claim 5, wherein when the sub division information indicates that the block is divided using the sub division structure and there are multiple sub division structures, the block division information further includes information for specifying one of the sub division structures.

7. The method of claim 5, wherein when the main division information indicates that the block is not divided using the main division structure and the sub division information indicates that the block is not divided using the sub division structure, the current block is determined as a coding unit.

8. The method of claim 1, wherein the block division information includes first information for indicating whether the block is divided, and
when the first information indicates that the block is divided and multiple division structures are used for dividing the block, the block division information further includes second information for specifying one among the multiple division structures.

9. The method of any one of claims 3 to 7, wherein information on the main division structure or on the sub division structure is encoded at least one level among a sequence level, a picture level, a slice level, a tile level, and a block level.

10. The method of any one of claims 1 to 9, wherein the division of the block is not performed on a block in a predetermined size or less, and
information on the predetermined size is encoded at least one level among a sequence level, a picture level, a slice level, a tile level, and a block level.

11. The method of claim 1, wherein the encoding of the current block or the sub block, at the encoding step, includes at least one among prediction, transform, and quantization,
the transform includes non-square shape transform, and
the transform is performed by Y=AXBT (wherein, X denotes a residual signal block in an m×n size, A denotes one-dimensional n-point transform in a horizontal direction, BT denotes one-dimensional m-point transform in a vertical direction, and Y denotes a transform block obtained by transforming X).

12. The method of claim 11, wherein the A and the B are different transforms.

13. A video signal processing method of dividing an input image on a per-block basis for decoding, the method comprising:
decoding block division information of a current block;
dividing, at a block division step, the current block into multiple sub blocks on the basis of the block division information; and
decoding the current block or the sub blocks.

14. A video signal processing device of dividing an input image on a per-block basis for encoding, the device comprising:
a division determination module determining whether to divide a current block;
a block division module dividing the current block into multiple sub blocks on the basis of the determination;
a block division information generation module generating block division information on division of the current block; and
an encoding module encoding the block division information, the current block, or the sub blocks.

15. A video signal processing device of dividing an input image on a per-block basis for decoding, the device comprising:
a block division information decoding module decoding block division information of a current block;
a block division module dividing the current block into multiple sub blocks on the basis of the block division information; and
a block decoding module decoding the current block or the sub blocks.
